(19) United States
(12) Patent Application Publication
(10) Pub. No.: US 2024/0220914 A1
(43) Pub. Date: Jul. 4, 2024

(54) SELF-HEALING LOGISTICS NETWORK TECHNOLOGY

(71) Applicant: UNITED PARCEL SERVICE OF AMERICA, INC., Atlanta, GA (US)

(72) Inventors: Jethro BONAFE, Atlanta, GA (US); Christopher AZAR, Atlanta, GA (US); Dennis BAUTISTA, Atlanta, GA (US); Vincent PIZZUTO, Atlanta, GA (US); Derek UBER, Atlanta, GA (US)

(21) Appl. No.: 18/091,204

(22) Filed: Dec. 29, 2022

(51) Int. Cl. G06Q 10/0833; G06K 19/077

(52) U.S. Cl. CPC G06Q 10/0833; G06K 19/07758

(57) ABSTRACT

Some embodiments are directed to using tag-reader technologies in order to provide optimized visualization of assets throughout a logistics network, which is used to make associated predictions. Particular reader devices dispersed throughout the logistics network derive data from tags coupled to assets that are in transit within the logistics network. In some embodiments, this data is fed into a computer model as input to make certain predictions and responsively cause a corrective action to be made within the logistics network, which offsets any logistics network operation disruptions.

### BACKGROUND

In the shipping industry, before an asset (e.g., a package, a container, or bag of small items) reaches a final delivery destination, it typically goes through various operations in a logistics network. For instance, after a package has been dropped off at a carrier store for a delivery request, it is routed to one or more sorting facilities, such as a hub. The package may traverse various different conveyor belt assemblies and go through different sorting processes in the hub based on information associated with the package (e.g., size of package, destination address, weight, etc.). After traversal of the package through the hub, a user may load the package into a logistics vehicle (e.g., a package car) for delivery to the final delivery destination or delivery to the next sorting facility. During an asset's transit through the logistics network, one or more events may disrupt operation, such as a weather event that shuts down an entire sorting facility, a breakdown of an individual conveyor belt assembly in the sorting facility, a workforce shortage, and the like.

Existing technologies for repairing logistics network operation disruptions and detecting a location of assets in a logistics network in general have many shortcomings. These technologies have limited functionality, are inaccurate, negatively impact the user experience, and unnecessarily consume computing resources, among other technical problems. For example, carrier package scanning devices include components (e.g., a trigger mechanism) that require tedious manual user input, which causes likelihood of inaccuracies, among other technical problems. In another example, location-sensing technologies, such as Global Positioning System (GPS) technologies, are incapable of, or have difficulty with, detecting assets inside logistics enclosures, such as a sorting facility.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter. Further, alternative or additional embodiments exist other than those described in this summary section.

Some embodiments are directed to using tag-reader technologies (e.g., Radio Frequency Identification (RFID)) to provide optimized visualization of assets throughout a logistics network, which is used to make associated predictions. Particular reader devices dispersed throughout the logistics network derive data from tags coupled to assets (and/or the logistics network) that are in transit within the logistics network. In some embodiments, this data is fed into a computer model (e.g., a machine learning model) as input to make certain predictions and responsively cause a corrective action to be made within the logistics network, which offsets any logistics network operation disruptions.

In an illustrative example of the predictions, they can include any of the following: a predicted volume of assets, a predicted sorting center or logistics vehicle to receive an asset as part of a reroute operation, a prediction of whether a sorting facility is incapable of sorting the asset, a prediction of whether a piece of equipment is faulty, a prediction of whether the asset is in distress while traversing the logistics network, and a predicted time of arrival for the asset.

In an illustrative example of the corrective action, they can include any of the following: causing an asset to be redirected from a first sorting facility to a second sorting facility as part of a reroute operation, causing the asset to be loaded into a first logistics vehicle instead of a second logistics vehicle as part of the reroute operation, transmitting a control signal to a logistics vehicle or vessel to speed up delivery of the asset, transmitting a control signal to equipment to change operation of the equipment or change a route that the asset takes, and transmitting a notification to a user device that indicates the prediction.

### BRIEF DESCRIPTION OF THE DRAWINGS

Having thus described the disclosure in general terms, reference will now be made to the accompanying drawings, which are not necessarily drawn to scale, and wherein:

FIG. 1 is a schematic diagram of an example logistics network that is equipped with various tags and readers in order to make a prediction, via a computer network(s), to perform a corrective action within the logistics network, according to some embodiments;

FIG. 2 is a block diagram illustrating an example computing system architecture suitable for implementing embodiments of the disclosure;

FIG. 3 is a schematic diagram depicting a top view of a logistics facility, which illustrates location sensing technology infrastructure, according to some embodiments;

FIG. 4 is a schematic diagram of an example logistics vehicle, according to some embodiments.

FIG. 5 is a schematic diagram of a sorting facility illustrating how one or more assets may interact with various reader devices, according to some embodiments;

FIG. 6 is a schematic diagram of an example tag-reader environment for detecting and following a location of the asset from the conveyor belt assembly to its loading within a logistics vehicle, according to some embodiments;

FIG. 7 is a schematic diagram illustrating how a neural network makes particular training and deployment predictions given specific inputs, according to some embodiments;

FIG. 8A is a schematic diagram of a storage unit that illustrates which particular storage unit an asset is predicted to be located in and/or where an asset's exact location within the storage unit is, according to some embodiments;

FIG. 8B is a schematic diagram of the storage unit of FIG. 8A, which that illustrates how to predict or detect an asset's (or tag coupled to the asset's) exact location within a storage unit, according to some embodiments;

FIG. 8C illustrates data points in dimensional or vector space that represent the signal strength indications of FIGS. 8A and 8B, according to some embodiments;

FIG. 9 is a flow diagram of an example process for training a machine learning model on various historical tag-reader data sets, according to some embodiments;

FIG. 10 a process for causing a corrective action associated with a logistics network to be made based at least in part on a score indicative of a prediction associated with the logistics network, according to some embodiments;

FIG. 11 is a schematic diagram of an example computing environment in which aspects of the present disclosure are employed in, according to some embodiments;

FIG. 12 is a block diagram of the analysis computing entity of FIG. 11, according to some embodiments; and

FIG. 13 is a block diagram of the source computing entity of FIG. 11, according to some embodiments.

### DETAILED DESCRIPTION OF THE INVENTION

The present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. Like numbers refer to like elements throughout.

### I. Overview

As described above, existing carrier package scanning device systems lead to technical problems, such as low visibility of assets in a logistics network. Carrier package scanning devices typically require users to manually point a carrier package scanning device at a shipping label. They also typically include a mechanical trigger that, upon user decompression, activates a 2D imager (e.g., a photodiode) to read a bar code located on the shipping label and convert it into an electrical signal. Decoders of the carrier package scanning device further typically take the binary code read by the 2D imager and convert it to usable information, such as a natural language tracking number, a package identifier, or other information. Such data provides relevant information associated with an asset, such as its dimensions, weight, destination, and the location of the read.

The user is typically only required to manually scan, via the carrier package scanning device, each package at a few predetermined points along the logistics network. For example, a package scanning device may only scan a package when a delivery request goes out at a shipping store, before the package traverses through a hub, and when the package is associated to a particular logistics vehicle it is assigned to be loaded in. After scanning, the user must then then provide manual computer user input associating each package to the logistics vehicle or logistics facility. For example, for each of 50 packages a user is to load in a first package car, the user must push the mechanical trigger at least 50 times for the carrier package scanning device to read each respective bar code. Then, for each of the 50 packages, the user must then manually input (e.g., at an electronic spreadsheet) data, which indicates that the respective package is assigned to be placed in a particular logistics vehicle or has been scanned at a particular logistics facility (e.g., a hub).

However, there are many locations (e.g., along a conveyor belt and inside a logistics vehicle) within the logistics network where packages are not read by these package scanning device systems. Accordingly, there is a large quantity of time between package scanning device reads. Therefore, these package scanning device systems are inaccurate or fail to follow (e.g., in near-real-time) assets in a logistics network, thereby negatively impacting the visibility of these assets or detection of a particular problem (e.g., an asset is stuck on a conveyor belt).

Consequently, these technologies are unable to be used for repairing logistics network operation disruptions, especially in near-real-time relative to the time at which a problem is detected in the logistics network. For example, if a hurricane was detected around a first hub, in order to repair logistics network operations, these package scanning device systems require a manual database or electronic spreadsheet lookup (the same database or spreadsheet the user used to associate the package to a car or logistics facility) to see where the last read was. Then these databases or electronic spreadsheets would be required to receive manual inputs from an administrator, which reflects manual decision making as to where the assets should be redirected. These computing systems would then have to push notifications to particular user devices so that logistics network personnel can manually correct disruptions. For example, these systems may push a notification to a delivery driver's mobile device so that the delivery driver knows that the transit destination of a package has changed from the first hub to a second hub. However, these manual computing processes are inaccurate, slow, and tedious—by the time re-routing decisions have been made, databases or electronic spreadsheets have been updated, and/or notifications pushed, there are many assets that are deep in transit to the first hub, which means that many assets are inaccurately and unnecessarily in transit (e.g., in the wrong logistics vehicle) to the first hub. Further, such sheer quantity of times these carrier package scanning devices require trigger decompression and pointing at a shipping level negatively impacts the user experience, as these steps are tedious and arduous.

Moreover, these carrier package scanning technologies unnecessarily consume computing resources. As stated above, for each package a user is loading in each particular logistics vehicle, the user is typically required to manually scan each package and then provide manual computer user input associating each package to a logistics vehicle or logistics facility. However, such manual computer user input increases storage device input/output (I/O), packet generation/network costs, and the like. For example, manual data entry of a spreadsheet in these systems increase storage device I/O (e.g., excess physical read/write head movements on non-volatile disk). This is because each time a user inputs this information (because the user has to associate each package, of multiple packages, with the logistics vehicle or logistics facility), the computing system has to traverse a network and reach out to a storage device to perform a read or write operation. This is time consuming, error prone, and wears on components, such as a read/write head. Reaching out to disk is also very expensive because of the address location identification time and mechanical movements required of a read/write head.

As described above, location-sensing technologies, such as Global Positioning System (GPS) technologies, are incapable of, or have difficulty with, detecting assets inside a logistics enclosure, among other technical problems. The proliferation of wireless technologies, mobile computing devices, apps, and the Internet has fostered a growing interest in location-aware technologies. These technologies can locate objects using techniques such as Global Position System (GPS) triangulation or the like. Typical location-sensing technologies include static components or are limited in functionality. This can cause, among other things, inaccurate determination of whether assets are located in a logistics vehicle of other logistics facility, such as a hub.

In an illustrative example, although some conventional solutions use tracking technologies, such as Global Positioning Systems (GPS) to track items, they have an inherent problem of accurately determining locations of objects inside logistics vehicles or other enclosed areas, such as hubs, or logistics stores. In most indoor cases, GPS signals will be blocked or reflected by walls and have difficulty entering an enclosed area. As a result, satellite signals cannot be received properly, so it may be impossible or difficult to calculate location due to the insufficient signal strength inside the enclosed area.

To resolve these issues, particular indoor location-sensing technologies have been developed. For example, certain infrared indoor location technologies use diffuse infrared technology to realize indoor location positioning. However, the line-of-sight requirement and short-range signal transmission are two limitations that suggest it to be less than effective in practice for indoor location sensing. Ideally, wireless communication between devices occurs via a line-of-sight path (i.e., waves travel in a direct path) between transmitter and receiver that represents clear spatial channel characteristics. However, with these existing technologies, communications would not occur via a line-of-site path because of physical barriers or other interference obstacles in a logistics vehicle or facility (e.g., conveyor belt assemblies, fork lifts, etc.) between transmitter and receiver. This can cause reflection, attenuation (or fading), phase shift, and/or distortion (e.g., due to noise) of the signals among other things, thereby reducing performance, such as communication between devices based on reduced signal strength.

Various embodiments of the present disclosure provide one or more technical solutions to one or more of these technical problems described above. Some embodiments are directed to using tag-reader technologies (e.g., Radio Frequency Identification (RFID)) in order to provide optimized visualization of assets throughout most or all of a logistics network. Additionally, these embodiments use computer models (e.g., a machine learning model) to make certain predictions (e.g., a volume forecast of assets flowing through a sorting center) and responsively cause a corrective action to be made within the logistics network, which offsets any logistics network operation disruptions. In operation, some embodiments receive a first indication that a first reader device (e.g., a RFID reader) has read data of a tag (e.g., a RFID tag) coupled to a first asset during transit through a logistics network. The first reader device is coupled to a first enclosure (e.g., a logistics store, a package car, or a sorting facility) of the logistics network. Based at least in part on the first indication, some embodiments generate, via a model, a score indicative of a prediction associated with the logistics network. For example, the score can indicate: a predicted volume of assets that will arrive at or be processed at a sorting center, a predicted sorting center (or logistics vehicle) to receive one or more assets as part of a reroute operation, a prediction of whether a sorting facility is/will be inoperable (e.g., because of a hurricane), a prediction of whether a piece of equipment (e.g., a conveyor belt assembly) is faulty, a prediction of whether an asset is in distress (e.g., stuck on a conveyor belt) while traversing the logistics network, a predicted time of arrival for one or more assets, and the like. In an illustrative example, if a reader in the first sorting facility reads X quantity of tags with Y destination, it is predicted that X quantity of assets will arrive at sorting facility 2, which is used to route assets to Y destination.

Based at least in part on the score, some embodiments cause a corrective action associated with the logistics network to be made. For example, such “corrective action” may be or include: causing a first asset to be redirected or rerouted from a first sorting facility to a second sorting facility, causing the first asset to be loaded into a first logistics vehicle instead of a second logistics vehicle, transmitting a control signal to a logistics vehicle (e.g., an autonomous vehicle) or vessel (e.g., an Unmanned Aerial Vehicle (UAV) or robot) to speed up delivery of the first asset, transmitting a control signal to equipment to change operation of the equipment (e.g., speed up a conveyor belt) or change the route that the first asset takes, and/or transmitting a notification to a user device that indicates the prediction.

Particular embodiments improve package scanning device systems. For example, particular embodiments improve the user experience, human-computer interaction, and accuracy. For example, using the illustration above, for each of 50 packages a user is to load in a first package car, the reader device automatically reads a respective tag in response to an antenna of the reader device and tag being within a signal strength, communication range, or distance threshold. In this way, unlike carrier package scanning devices, the user need not push the mechanical trigger at least 50 times for the carrier package scanning device to read each respective bar code. Accordingly, one technical solution is that one or more reader devices are configured to automatically read the data from the tag, instead of requiring a manual pointing and decompression of a trigger.

One technical solution is receiving an indication that one or more reader devices has read data of a tag coupled to one or more assets during transit through a logistics network. This has the technical effect of a near real-time or continuous read of a tag throughout the logistics network. In other words, the technical effect is being able to follow or detect a near real-time location of the tag as the tag traverses a logistics network. For example, each asset that is in transit in a logistics network can be equipped with a tag. Likewise, in some embodiments, each logistics enclosure, such as a package car, multiple sorting centers, and a logistics store, is equipped with a reader that is configured to read a corresponding tag coupled to an asset such that the asset can be followed throughout the entire logistics network. Accordingly, instead of the user being required to manually scan, via the carrier package scanning device, each package at a few predetermined points along the logistics network, particular embodiments receive an indication that one or more reader devices have read a tag while the tag is in transit through the logistics network. Consequently, there is no need for the user to then provide manual computer user input associating each package to the logistics vehicle or logistics facility. There are many locations (e.g., along a conveyor belt and inside a logistics vehicle) within the logistics network where tags are read by these reader devices (unlike package scanning device systems). Accordingly, relative to existing technologies, there is little to no time between reader device reads. Therefore, these embodiments follow (e.g., in near-real-time) assets in a logistics network, thereby improving the visibility of these assets or detection of a particular problem unlike existing technologies.

Particular embodiments also improve the manual process of repairing logistics operation disruptions, especially in near-real-time relative to the time at which a problem is detected in the logistics network. For example, using the illustration above, if a hurricane was detected around a first hub, in order to repair logistics network operations, particular embodiments use a model (e.g., a machine learning model) to automatically generate a score, which is indicative of where the assets should be re-routed to, based on past historical decisions (e.g., a machine learning model that is trained on what hub packages have been re-routed to when there is a disruption of a particular hub). In other words, there is no need for a manual database or electronic spreadsheet lookup to see where the last read was because of the ability to track (e.g., in near-real-time) assets based on tag-reader reads. Consequently, there is no need for these databases or electronic spreadsheets to receive additional manual inputs from an administrator, which reflects manual decision making as to where the assets should be redirected. Rather, the model makes these decisions (which may be based on unique rules). In this way, if particular embodiments push a notification to a delivery driver's mobile device so that the delivery driver knows that the transit destination of a package has changed from the first hub to a second hub, the processes are accurate and less tedious because of the improved tag-reader visualization and automated model calculation. Accordingly, unlike existing technologies there will not be as many assets that are deep in transit to the first hub, which means that many assets are accurately in transit (e.g., in the correct logistics vehicle) to the correctly designated hub. Therefore, one technical solution is the generating, via a model, of a score indicative of a prediction associated with an enclosure. To this end, one technical solution is the training of a machine learning model, where the score is based on the training. And another technical solution is the causing of a corrective action associated with the logistics network to be made based at least in part on the score.

Moreover, particular embodiments improve computing resource consumption relative to existing carrier package scanning technologies. As stated above, the user is typically required to manually scan each package and then provide manual computer user input associating each package to the logistics vehicle, sorting facility, or other logistics enclosure. However, as described above, particular embodiments do not require such manual computer user input. Therefore, there is a reduction in storage device input/output (I/O), packet generation/network, costs, and the like. For example, generating, via a model, a score indicative of a prediction based at least in part on receiving an indication that a first reader device has read data of a tag, reduces storage device I/O (e.g., excess physical read/write head movements on non-volatile disk). This is because the user does not have to manually associate a package with an enclosure (e.g., via a spreadsheet), such as by putting in the name of the package, the name of the vehicle, destination, and the like. Accordingly, the computing system does not have to traverse a network and reach out to a storage device to perform a read or write operation as often. Therefore, embodiments are less error prone, and wears less on components, such as a read/write head, due to the reduced mechanical movements.

Particular embodiments also improve location-sensing technologies, such as Global Positioning System (GPS) technologies, because they are capable of, or are more accurate in, detecting assets inside a logistics enclosure. One technical solution is one or more reader devices, antennas, or reference tags coupled to a logistics facility or enclosure (e.g., an inside housing of a logistics vehicle). Another technical solution is one or more reader devices or reference tags coupled to an environment (e.g., hub walls) a user is in, which is outside the logistics vehicle. Accordingly, because these devices are coupled to an inside housing or an environment the user is in, the signals have less chance of being blocked or reflected by walls and have less difficulty entering an enclosed area, unlike GPS signals. As a result, there is sufficient signal strength between tags and readers inside the enclosed area, thereby allowing embodiments to accurately detect whether assets are in particular logistics enclosures based on the unfettered communication and signal strength between antennas of readers and tags.

Some embodiments improve technologies, such as Active badge, via the use of tags and readers, such as RFID, which does not have strict line-of-sight requirements relative to Active badge. Some embodiments also improve these technologies via the use of multiple “reference” tags and/or reader devices inside a logistics vehicle or environment that the user is in. In this way, even if communications does not occur via a line-of-site path because of physical barriers or other interference obstacles in a logistics network between a single reader device and tag, there are other tags or readers in differing positions to avoid line-of-site issues. This reduces reflection, attenuation (or fading), phase shift, and/or distortion (e.g., due to noise) of the signals among other things, thereby increasing performance, such as signal strength. Using this new infrastructure setup, some embodiments can perform new functionality by detecting whether an asset is in a particular area within the logistics network (e.g., a storage unit) based on the proportion of tags mapped to a storage device that are currently being read by a reader device (e.g., the user's wearable reader).

Employing multiple readers and/or tags in fixed locations in different geographical areas along the logistics network allows for redundancy checks, which improves existing technologies. The benefit of redundancy in these embodiments is that there may be multiple tags and/or readers in near positions such that any interference or noise experienced at one tag and/or reader location does not typically affect sensor readings of all of the other tags/readers. Employing multiple tags and/or readers at different locations increases the likelihood that not all reader/tag pairs will be subject to the same interference or noise at the same time, thereby allowing more accurate readings for location sensing of asset tags.

In is understood that although this overview section describes various improvements to conventional solutions and technologies, these are by way of example only. As such, other improvements are described below or will become evident through description of various embodiments. This overview is provided to introduce a selection of concepts in a simplified form that are further described below in the detailed description. This overview is not intended to: identify key features or essential features of the claimed subject matter, key improvements, nor is it intended to be used in isolation as an aid in determining the scope of the claimed subject matter.

### II. Example Environment

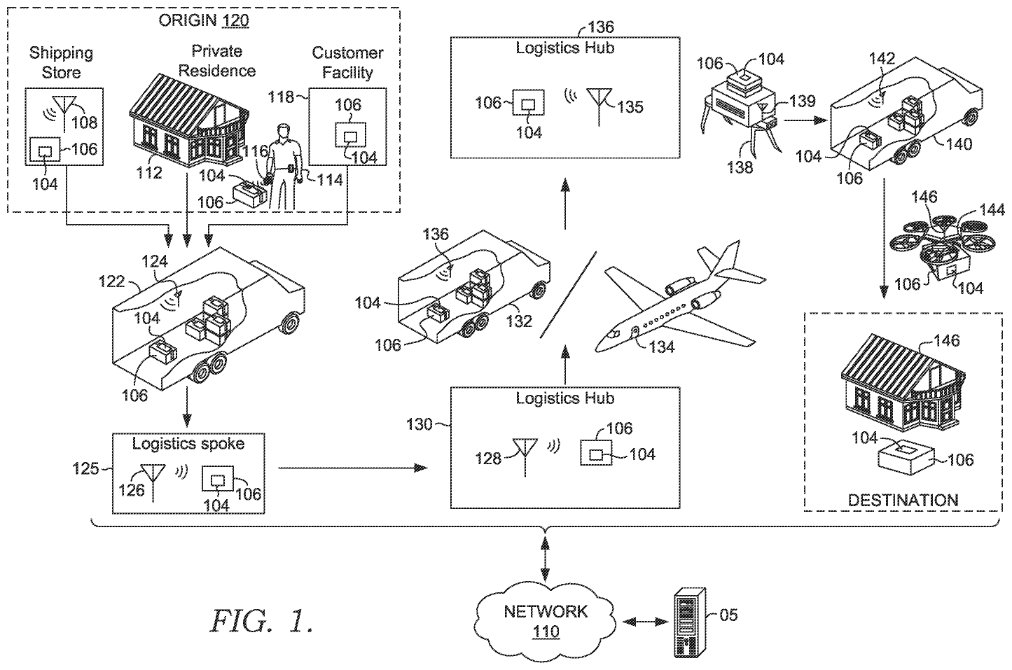

FIG. 1 is a schematic diagram of an example logistics network 100 that is equipped with various tags and readers in order to make a prediction, via the computer network(s) 110, to perform a corrective action within the logistics network 100, according to some embodiments. The logistics network 100 includes an origin 112 (which includes the shipping store 102, the private residence 112, and/or the customer facility 118), a first logistics vehicle 122, one or more logistics spokes 125, a logistics hubs 130, a second logistics vehicle 132 and/or 134, a second logistics hub 136, an autonomous bot 138, a third logistics vehicle 140, an Unmanned Aerial Vehicle (UAV) 144, and a final-mile destination location 146. Each of the tags and/or readers illustrated in FIG. 1 are communicatively coupled to the analysis computing entity(s) 05 via the computer network(s) 110 so that a prediction can be made (e.g., that the logistics hub 130 will receive X quantity of packages based on Y quantity of tags that were read at the logistics spoke 125).

FIG. 1 illustrates detecting the location of the tag 104 (e.g., in near-real-time) or otherwise following the tag 104 as it traverses through the logistics network 100 as represented by the direction arrows—the tag 104 is first detected at the origin 112, then in the first logistics vehicle 122, then in one or more logistics spokes 125, then in the logistics hub 130, then in the second logistics vehicle 132 and/or 134, then in the second logistics hub 136, then at the autonomous bot 138, then inside the third logistics vehicle 140, then at the Unmanned Aerial Vehicle (UAV) 144, and then finally at the final-mile destination location 146.

The asset 106 first originates at the shipping store 102, the private residence 112, or the customer facility 118. The shipping store 102 is a facility that customers can drop their assets off at to initiate the shipping process, such as via printing a shipping label, fixing the shipping label to the asset 106, fixing the tag 104 to the asset 106, billing processes, and/or scanning/entering various information associated with the asset 104, such as destination address and size information (e.g., dimensions and weight) of the asset 106. The shipping store 108 includes one or more reader devices 108 that are configured to read data from the tag 104. In response to the reader device 108 reading data from the tag 104, the reader device 108 transmits, via the computer network(s) 110, the data to the analysis computing entity 05 in order to detect the presence or location of the asset 106, as described in more detail below.

In some embodiments, a “reader device” as described herein is any suitable reader machine, manufacture, or module that is configured to read data (e.g., a tag ID) stored to a tag. For example, a reader device can be Radio Frequency Identification (RFID) reader, a Near-field Communication (NFC) reader, an optical scanner, an optical reader, a bar code scanner, a wand, a magnetic ink character recognition reader, a beacon reader, or the like.

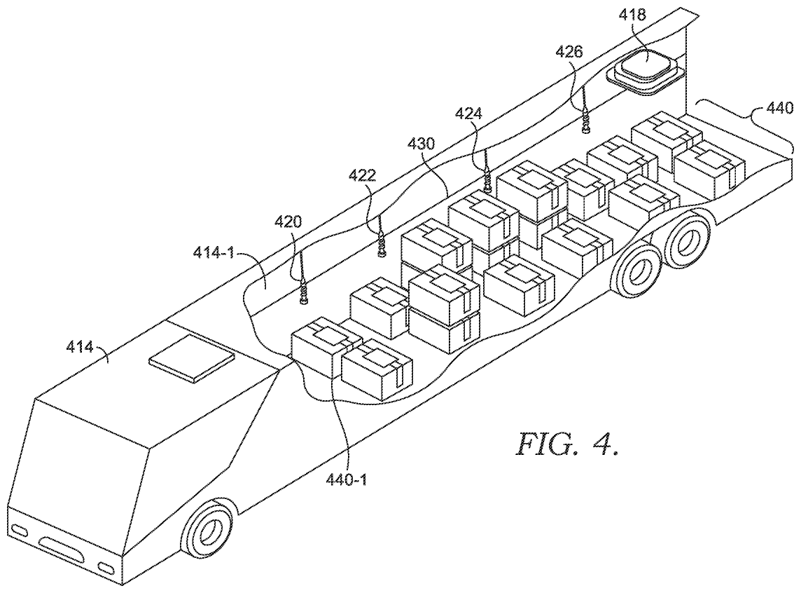

In some embodiments, a “tag” as described herein is any physical object that stores, at minimum, an identifier that identifies the tag and/or other unique data. The identifier (and potentially other data) is configured to be read by a reader device. For example, in some embodiments, a RFID tag includes an antenna or radio (for transmitting and receiving its tag ID) and a RFID chip (e.g., an integrated circuit), which store's the tag's ID and other information. In another example, a tag is or includes a paper label with a matrix or barcode with an encoded ID. In some embodiments, a tag is an integrated circuit that is embedded within or is otherwise a part of a shipping label. It is understood that although FIG. 4 illustrates detecting the location of a single tag 104 throughout the logistics network, particular embodiments detect the location of multiple tags, each being coupled to a respective asset such that multiple tags can be simultaneously followed.

In some embodiments, so long as any reader device within the logistics network 100 is within a distance or communication range to the tag 104, the respective reader device reads data from the tag 104 and sends the readings to the analysis computing entity 05 in near-real-time or at every X time period (e.g., every 1 second). In some embodiments, the sending of the readings occurs at every batched time interval. For example, a reader device can sample or obtain readings and populate a corresponding record every 2 seconds (e.g., populate a first record with a first time stamp, where the record includes a received tag ID and reader device ID). However, the reader device may only send the readings once every 5 minutes such that multiple batched records of tag-reader readings are sent every 5 minutes.

In some embodiments, any reader device or tag combination described herein is part of a Radio Frequency Identification (RFID) system. Accordingly, these components may include the components and functionality of RFID tags and readers, for example. RFID is a way to store and retrieve data through electromagnetic transmission to an RF compatible integrated circuit. An RFID reader device can read data emitted from or located within RFID tags. RFID readers and tags used a defined radio frequency and protocol to transmit or provide (via tags) and receive (via reader devices) data. RFID tags are categorized as at least passive or active. Passive RFID tags operate without a battery. They reflect the RF signal transmitted to them from a reader device and add information by modulating the reflected signal. Their read ranges are limited relative to active tags. Active tags contain both a radio transceiver and a battery to power the transceiver. Since there is an onboard radio on the tag, active tags have more range than passive tags. Active tags use a battery power source to broadcast their signal automatically, and a passive RFID tag does not have any power source. Passive tags only transmit RFID signals when receiving a radio frequency energy (an interrogation signal) from an RFID reader that is within range. It is noted however, that the reader devices or tags need not be a part of RFID protocols, but can alternatively or additionally include other protocols, such as BLUETOOTH LOW ENERGY (BLE), Bar codes, QR codes, and the like.

Continuing with FIG. 1, in some embodiments, the originating location of the asset 106 is the private residence 106. In these embodiments, the wearable reader device 116 automatically receives data from the tag 104 (which is fixed to the asset 106 by the resident) in response to an antenna of the reader device 116 being within a distance and/or communication range threshold of the tag 104. In this way, inferences that the delivery driver 114 has picked up the asset 106 can be made. For example, in response to the wearable reader device 116 receiving or decoding a tag ID of the tag 104, the wearable reader device 116 transmits, over the computer network 110, both the tag ID and its own wearable reader device ID to the analysis computing entity 05. The analysis computing entity 05 then associates (e.g., via a lookup data structure or database) the wearable reader device 116 to a name of the user 114 in order to infer that the user 114 has picked up the package 106. The wearable reader device 116 is described in more detail below. In some instances, the user 114 can alternatively pick up the asset 106 from the shipping store 102 or the customer facility 118 and the same functionality can be performed by the wearable reader device 116 and the analysis computing entity 05.

In some embodiments, the asset 106 originates at the customer facility 118. In some embodiments the customer facility 118 is an e-commerce fulfillment center. An e-commerce fulfillment center is the physical location from which the third-party logistics provider fulfills consumer orders for e-commerce retailers. In some embodiments, the customer facility 118 is a warehouse of inventory of a particular shipper. In some embodiments, the customer facility 118 is equipped with one or more reader devices to read data from the tag 104. In this way, an inference can be made that the asset 106 is detected as being within the customer facility 118.

The user 114 picks the asset 106 from the origin 120 and loads the asset 106 to the logistics vehicle 122. In some embodiments, the user 114 alternatively represents the delivery bot 138 (e.g., an Unmanned Ground Vehicle (UGV)) or the UAV 144. The first logistics vehicle 122 includes one or more reader devices 124 that are configured to read data from the tag 104 in response to one or more antennas of the one or more reader devices 124 being within a distance or communication range threshold of the tag 104. In response to such reading and decoding of the data from the tag 104, in some embodiments, the reader device 124 transmits the tag data, via the network(s) 110, to the analysis computing entity 05 to detect that the asset 106 is inside of the logistics vehicle 122, as described in more detail below.

The asset 106 is then unloaded (e.g., by the user 114, the delivery bot 138, or the UAV 144) from the logistics vehicle 122 and then placed into the logistics spoke 125. The logistics spoke 125, the logistics hub 130, and the logistics hub 136 are a part of a hub and spoke model. This model is a centralized warehousing and shipment system that resembles the structure of a bicycle wheel. The center of the wheel is a logistics hub or a distribution center and each logistics spoke represents a direction of delivery. A single logistics hub is configured to service and process shipment volume from multiple logistics spokes. It is understood, however, that the logistics network 100 need not represent a hub and spoke model. Rather, for example, in some embodiments, the facilities 125, 130, and 130 represent facilities in a point-to-point distribution model. However, the hub and spoke model typically allows greater flexibility and a more efficient connection system by consolidating the efforts of hundreds of drivers and delivery executives to one dedicated center.

The logistics spoke 125 includes one or more reader devices 126 that are configured to read data from the tag 104 in response to one or more antennas of the one or more reader devices 126 being within a distance or communication range threshold of the tag 104. In response to such reading and decoding of the data from the tag 104, in some embodiments, the reader device 126 transmits the tag data, via the network(s) 110, to the analysis computing entity 05 to detect that the asset 106 is inside of the logistics spoke 125, as described in more detail below.

The asset 106 is then transferred (e.g., by a different user, delivery robot, or UAV) from the logistics spoke 125 to another logistics vehicle and/or the logistics hub 130. The logistics hub 130 includes one or more reader devices 128 that are configured to read data from the tag 104 in response to one or more antennas of the one or more reader devices 128 being within a distance or communication range threshold of the tag 104. In response to such reading and decoding of the data from the tag 104, in some embodiments, the reader device 128 transmits the tag data, via the network(s) 110, to the analysis computing entity 05 to detect that the asset 106 is inside of the logistics hub 130, as described in more detail below.

The asset 106 is then transferred (e.g., by a different user, delivery robot, or UAV) from the logistics hub 130 to another logistics vehicle 132 (e.g., a package trailer) or logistics vehicle 134 (e.g., a logistics aircraft), which also includes one or more reader devices 136 in order to detect that the asset 106 is inside the logistics vehicle 132/134 via one or more tag readings of the tag 104. The asset 106 is then transferred from the logistics vehicle 132/134 to the logistics hub 136. The logistics hub 136 includes one or more reader devices 135 that are configured to read data from the tag 104 in response to one or more antennas of the one or more reader devices 135 being within a distance or communication range threshold of the tag 104. In response to such reading and decoding of the data from the tag 104, in some embodiments, the reader device 135 transmits the tag data, via the network(s) 110, to the analysis computing entity 05 to detect that the asset 106 is inside of the logistics hub 136, as described in more detail below.

The delivery bot 138 then transfers the asset 106 from the logistics hub 136 to the logistics vehicle 142. In some embodiments, a delivery bot 138 represents an autonomous UGV or any autonomous robot. The autonomous robot can include features representing legs or wheels to traverse, and/or features representing hands to clasp the asset 106. In some embodiments, the delivery bot 138 includes various sensors, such as radar, lidar, and/or an object detection camera in order to map out its surroundings and detect objects for traversal through the logistics network 100. In some embodiments, in order for the delivery bot 138 to traverse autonomously, the delivery bot 138 executes one or more machine learning models (e.g., a Convolutional Neural Network (CNN)) to detect objects in an environment. For example, camera video data can be feed to a CNN so that the CNN can predict different real-world objects by placing bounding boxes over the different objects (e.g., a logistics vehicle, a conveyor belt, etc.) to assist the delivery bot 138 in traversing, for example, to the logistics vehicle 140. In some embodiments, the machine learning model is pre-trained by feeding different images to the model to learn real world objects and then fine-tuned to learn specific logistics-based objects and routes, such as what the logistics vehicle 140 looks like, the route to take from the logistics hub 136 to the logistics vehicle 140, and the like.

The delivery bot 138 includes a reader device 139 that is configured to read data from the tag 104 in response to an antenna of the reader device 139 being within a distance or communication range threshold of the tag 104. This may be indicative of the delivery bot 138 holding or otherwise carrying the asset 106. In response to such reading and decoding of the data from the tag 104, in some embodiments, the reader device 139 transmits the tag data, via the network(s) 110, to the analysis computing entity 05 to detect that the asset 106 is being carried by the delivery bot 138. For example, the reader device 139 may transmit a tag ID of the tag 104, as well as an ID that identifies the reader device. The analysis computing entity 05 can then read a database or data structure, such as a lookup table, to map the reader device ID to the identity of the delivery bot 138. Accordingly, the analysis computing entity 05 can then infer that the delivery bot 138 is carrying the asset 106.

The logistics vehicle 140 includes its own one or more reader devices 142, which are configured to read data from the tag 104. In response to such reading and decoding of the data from the tag 104, in some embodiments, the reader device 142 transmits the tag data, via the network(s) 110, to the analysis computing entity 05 to detect that the asset 106 is within the logistics vehicle 140.

The UAV 144 then transports the asset 106 from the logistics vehicle 140 to the final mile delivery destination 146. The UAV 144 includes a reader device 146 that is configured to read data from the tag 104 in response to an antenna of the reader device 146 being within a distance or communication range threshold of the tag 104. This may be indicative of the UAV 144 carrying the asset 106. In response to such reading and decoding of the data from the tag 104, in some embodiments, the reader device 146 transmits the tag data, via the network(s) 110, to the analysis computing entity 05 to detect that the asset 106 is being carried by the UAV 144. For example, the reader device 146 may transmit a tag ID of the tag 104, as well as an ID that identifies the UAV 144. The analysis computing entity 05 can then read a database or data structure, such as a lookup table, to map the reader device 146 to an identity of the UAV 144. Accordingly, the analysis computing entity 05 can then infer that the UAV 144 is carrying the asset 106. In some embodiments, the UAV 144 alternatively represents a human user or another delivery bot.

In some embodiments, the destination 146 represents a private residence dwelling. In some embodiments, the destination 146 represents a locker in a locker bank or access point. Access point lockers help make asset pickup easier for customers who cannot have their packages left at a door. Customers, for example, that might have missed a package during their home delivery, can utilize access point lockers to receive deliveries on their schedule. In some embodiments, the destination 146 represents a partnering retailer or place of business. For example, a partnering retailer may be a business that is contracted with a logistics provider so that logistics provider personnel can drop off assets at the retailer and customers or consignees can pick up the assets at the retailer. In some embodiments, the customer facility 118 alternatively represents one or more access point lockers.

Some embodiments detect the location of the asset 106 near or by the delivery destination 146. For example, in some embodiments, an access point locker or contracting retailer may include one or more reader devices that are configured to read the tag 104 in response to an antenna of the reader device(s) being within a distance or communication range of the tag 104. Additionally or alternatively, a wearable reader device of a delivery driver can be configured to read the tag 104 in response to an antenna of the wearable reader device being within a distance or communication range threshold of the tag 104. In these embodiments, for example, in response to the wearable reader device reading the tag data, it can transmit the tag ID of the tag 104, as well as its own ID to the analysis computing entity 05 so that the analysis computing entity 05 can infer that the asset 106 is near a delivery destination based on mapping the wearable reader device ID to a particular delivery driver, who is assed to deliver the asset 106 to the destination 146.

As described above, at any point within the logistics network, a reader device can transmit tag-reader readings to the analysis computing entity 05 so that the analysis computing entity 05 can generate one or more scores indicative of one or more predictions associated with the logistics network 100. For example, in some embodiments, based on received timestamps of the tag readings of the tag 104 within the logistics vehicle 122 and logistics spoke 125, the analysis computing entity 05 can predict that the asset 106 will arrive at the destination 146 within a particular time range. This is only one example of many different potential use cases for predictions, which are described in more detail below.

In some embodiments, a “conveyor apparatus” as described herein, such as conveyor apparatus 102, includes any suitable conveyor belt assembly that includes a conveyor belt (continuous medium that carries parcels from one location to another) one or more rollers or idlers that rotate the belt or rotate such that the parcels are moved, and/or one or more pulleys (e.g., located on the ends of the conveyor apparatus 102) that transmit drive power into the belt. A conveyor apparatus, however, need not require a “belt” but can use rollers or other mechanisms to move parcels. The conveyor apparatus 102 may include a rotating component (e.g., a belt or set of rollers) that is configured to cause movement of one or more assets for loading the one or more assets.

### II. Example Computing Architecture

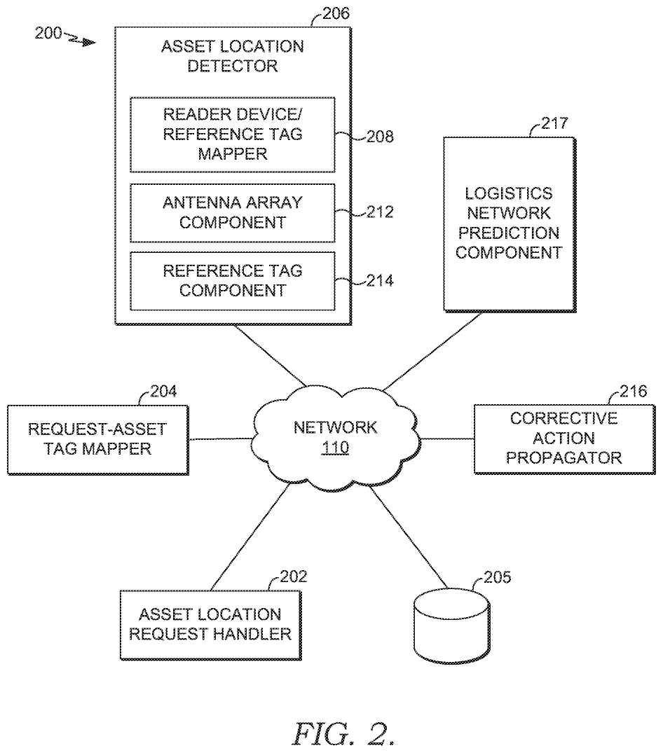

Referring now to FIG. 2, a block diagram illustrating an example computing system architecture (referred to as the “system 200”) suitable for implementing embodiments of the disclosure. The system 200 is generally responsible for detecting or predicting the location of a particular asset (or tag coupled to the asset) within a logistics network based on tag readings and responsively making predictions associated with a logistics network.

The system 200 includes an asset location request handler 202, a request-asset tag mapper 204, an asset location detector 206, a logistic network prediction component 217, a corrective action propagator 216, and storage 205, each of which is communicatively coupled via the one or more networks 110 of FIG. 1. The network(s) 110 is any suitable network(s), such as a Local Area Network (LAN), a Wide Area Network (WAN), the internet, or a combination of these, and/or include wired, wireless, or fiber optic connections. In general, network(s) 110 represent any combination of connections (e.g., APIs or linkers) or protocols that will support communications between the components of the system 200. In some embodiments, the components of the system 200 are embodied as a set of compiled computer instructions or functions, program modules, computer software services, logic gates, or an arrangement of processes carried out on one or more computer systems.

In some embodiments, the asset location request handler 202 is generally responsible for generating a request to execute one or more particular automated prediction commands or user requests. For example, referring back to FIG. 1, a user may explicitly issue a query that requests a prediction on the quantity of assets (the volume) that will arrive at the logistics hub 130. In some embodiments, the asset location request handler 202 is alternatively or additionally responsible for receiving a request to locate a particular asset within a logistics network (e.g., the logistics network 100) and programmatically calling other functions or components to trigger the execution of the request. For example, a user, such as a logistics hub manager may input, at a mobile device, a request to locate asset 106 of FIG. 1. In response to such input, the mobile device transmits, over the network 110, a request to a server (e.g., the analysis computing entity 05) to locate the asset 106. In some embodiments, the asset location request handler 202 then programmatically calls the request-asset tag mapper 204, the asset location detector 206, the logistics network prediction component 217, and/or the corrective action propagator 216, as described in more detail below.

The request-asset tag mapper 204 takes, as input, the request received from the asset location request handler 202, and then maps (e.g., via a hash map) the request to one or more tag IDs of tags coupled to one or more assets indicated in the request. In an illustrative example, there may be a request to re-route 4 packages from a first hub to a second hub. If a first delivery stop for a logistics vehicle is to be at a first address, the request-asset tag mapper 204 reads a data structure that indicates that the 4 packages with their corresponding IDs (e.g., as found in a package manifest) are to be delivered to the first address. This component may then look up, in a look-up table, each package ID as a key, and associate each package to the tag attached thereto by looking up the corresponding tag ID in the same record or entry of the look-up table. In some embodiments, the request-asset tag mapper 204 then programmatically calls the asset location detector 206 and passes along each tag ID of the 4 assets needing to be redirected so that the asset location detector 206 can perform its functionality, as described in more detail below.

The asset location detector 206 is generally responsible for receiving, as input, the tag IDs from the request-asset tag mapper 204 and then detecting a location and/or metadata (e.g., a time of a read) of corresponding asset(s) within the logistics network based on readings of corresponding asset tags. In some embodiments the asset location detector 206 detects asset location by generating a score that estimates the probability or likelihood (e.g., a confidence level interval) that an asset is located in a particular location. For example, the detection of asset location can include a continuum of probabilities that an asset is in different locations, which is directly proportional to the detected signal strength or presence of a read between antenna and asset tag. For example, the higher the signal strength between antenna and tag, the higher the probability that the asset is in a corresponding location and the lower the signal strength between antenna and tag, the lower the probability that the asset is in a corresponding location.

The asset location detector 206 includes a reader device/reference tag mapper 208, an antenna array component 212, and the reference tag component 214. The reader device/reference tag mapper 208 is generally responsible for mapping the tag IDs received from the request-asset tag mapper 204 to the corresponding tag IDs received from reader device(s) and/or reference tags within a logistics network. In this way, the reader device/reference tag mapper 208 can look up corresponding readings or signal strength values associated therewith. For example, if the mapper 208 receives tag ID of 1 (the asset tag) from the request-asset tag mapper 204, it can use tag ID 1 as a key to look-up near real time tag-reader values (e.g., signal strength) that particular reader device are reading from the corresponding tag. In some embodiments, the same mappings can be used to detect the location of corresponding assets. For example, the near real time tag-reader values can be placed in a first field of a record and the ID of the reader device reading the values can be placed in a second field of the same record. In this way, embodiments can determine that the asset tag is located in an enclosure that hosts the reader device. In some embodiments, the reader device/reference tag mapper 208 is alternatively or additionally responsible for mapping reader device IDs of reader devices within a logistics network to reference tag IDs of reference tags located within the logistics network.

In some embodiments, one or more “reference tags” are coupled to one or more surfaces within the logistics network, such as walls or ceilings of a logistics hub or logistics spoke. Reference tags and are generally responsible for indicating or emitting/transmitting data (e.g., to a respective antenna), such as an identifier that identifies the respective reference tag, which can be used to predict the location of a tag coupled to an asset, as described in more detail below. For example, indications that a similar signal strength profile between a first antenna device and a tag coupled to an asset and the first antenna device and a reference tag indicates that both tags are near each other and because the reference tag is mapped to a particular location within a logistics vehicle, the tag attached to the asset must be within or near the particular location.

The antenna array component 212 is generally responsible for detecting the location of an asset (or tag coupled to the asset) based on using multiple antennas within an enclosure (e.g., a logistics vehicle, a hub, or logistics store). In an illustrative example, each antenna, of multiple antennas that are spread out inside of a logistics vehicle, receives a tag ID from a tag (attached to a package) at a particular signal strength level (or the antenna emits an interrogation signal to an asset tag at the particular signal strength level). The higher the signal strength level, the closer the tag is to the antenna. Each antenna is mapped, via a data structure, to a specific location within the logistics vehicle indicating its location. Accordingly, a quick and dirty trilateration of the tag can occur via signal strength comparisons. In other embodiments, read counts or indication that a reader device at a specific location has read data from a specific tag can be used to detect location via the antenna array component 212, as described in more detail below.

The reference tag component 214 is generally responsible for detection the location of an asset (or tag coupled to the asset) based on using multiple reference tags within one or more enclosures of a logistics network. In an illustrative example, each reference tag, of multiple tags are spread out inside of a logistics hub. Each reference tag emits a tag ID at a particular signal strength level to one or more reader device antennas (or the one or more antennas emit an interrogation signal to each reference tags at the particular signal strength level). The tag located on a package also emits its own tag ID at a particular strength level. Each reference tag-antenna pair thus has its own signal strength level characteristics, which is then compared to a signal strength level characteristic between the tag located on the package and one or more antennas. The closer the match in signal strength level characteristics, the more likely that the tag attached to the asset is near the tag located in a predefined area within the logistics network. That is each reference tag is mapped, via a data structure, to a specific location within the logistics vehicle indicating its location. Accordingly, a quick and dirty trilateration of the tags can occur via signal strength comparisons.

It is understood that in some embodiments, only the antenna array component 212 is used by the asset location detector 206. In other embodiments, only the reference tag component 214 is used by the asset location detector 106. In yet other embodiments, a combination of both the antenna array component 212 and the reference tag component 214 are used by the asset location detector 206 to detect a location of an asset inside a logistics network. In some embodiments, responsive to the asset location detector 206 performing its functionality, the asset location detector 206 responsively causes tag-reader readings and metadata (e.g., timestamps of reader reads) to be stored as data records within the storage 205, which can be used as training data or baseline data for model predictions, as described in more detail below.

The logistics network prediction component 217 takes as input, the output produced by the asset location detector 206 or records stored to the storage 205, and generates one or more scores indicative of a prediction associated with the logistics network. For example, using the illustration above with respect to a request to reroute 4 packages from hub Y, the logistics network prediction component 217 generates a score indicating that the particular hub that the 4 packages should be re-routed to is hub Z based on historical tag-reader readings indicating that historical asset tags were followed or detected going to hub Z when hub Y was in operable in the past. The logistics network prediction component 217 is described in more detail below.

The corrective action propagator 216 takes as input, the score(s) generated via the logistics network prediction component 217, and is generally responsible for causing a corrective action to be made based on the score(s). For example, using the illustration above, based on the prediction that hub Z is the predicted hub to re-route the 4 packages to, the corrective action propagator causes transmission of a notification to a DIAD of a delivery driver, which instructs the driver to not drop off the 4 packages at hub Y, but hub Z.

The storage 205 (e.g., a database, RAM, cache, persistent storage, RAID, etc.) includes different data structures as described herein, such as the mappings used by the request-asset tag mapper 204 or the reader device/reference tag mapper 208. Additionally or alternatively, storage 205 includes any procedures, routines, or other logics described herein associated with the asset location request handler 202, the request-asset tag mapper 204, the asset location detector 206, and/or the control signal propagator.

### II. Example Logistics Facility

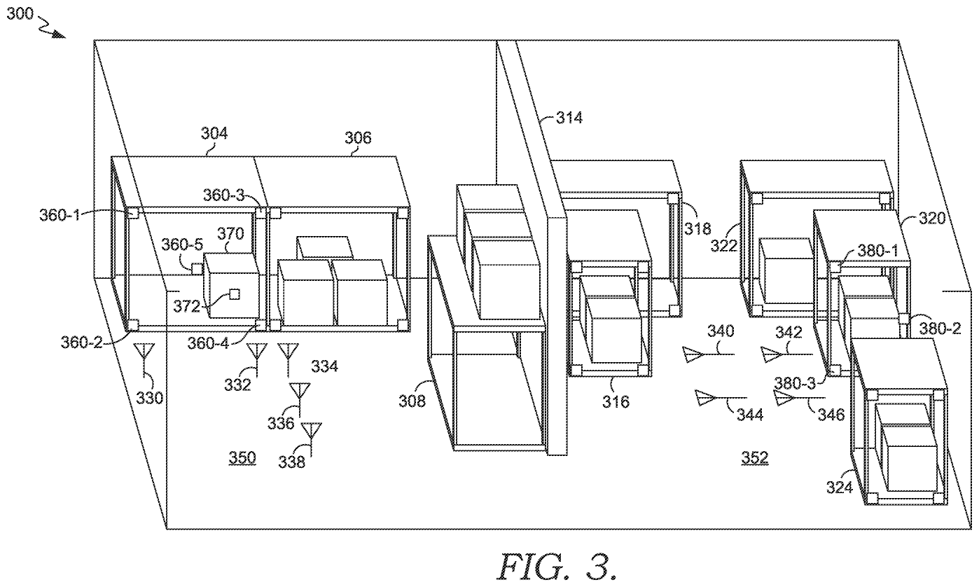

FIG. 3 is a schematic diagram depicting a top view of a logistics facility 300, which illustrates location sensing technology infrastructure, according to some embodiments. Although FIG. 3 depicts the facility 300 with two rooms 350 and 352, it is understood that this is representative only. As such, the location sensing technology infrastructure (e.g., the reference tags 360, the target tag 372, and the reader devices 330, 332, 334, 336, 338, 340, 342, 344, 346) may be located in any suitable geographical area and/or more or fewer reader devices, tags, assets, rooms, or sections may exist differently than presently illustrated. In some embodiments, the logistics facility 300 represents the customer facility 118, the shipping store 102, the logistics spoke 125, and/or the logistics hub 130 of FIG. 1.

The logistics facility 300 includes the storage units 304, 306, 308, 316, 318, 320, 322, and 324. The logistics facility 300 further includes the reference tags 360-1, 360-2, 360-3, 360-4, and 360-5 (collectively referred to herein as the reference tags 360) that are coupled to the storage unit 304, as well as multiple other reference tags (e.g., 380-1, 380-2, 380-3 (collectively referred to as reference tags 380) coupled to corresponding storage units. The logistics facility 300 further includes various reader devices-330, 332, 334, 336, 338, 340, 342, 344, and 346 (collectively referred to herein as “FIG. 4 reader devices”). The logistics facility 300 is also illustrated as containing two rooms or sections 350 and 352, which are separated by a divider or wall 314.

In various situations, a user, such as carrier personnel may be trying to locate the asset 370. In order to locate the asset 370, the user may issue a request (e.g., via the source computing entity 110) so that embodiments can predict the location of the asset 370. In various embodiments, the asset 370 has a predetermined ID, as indicated in a configuration file or mapping, which is described in more detail below. Some embodiments first predict what room (350 or 352) the asset 370 is located in based on what reader devices (or associated scanning antennas) associated with each room are currently reading or have received the ID of the asset 470 (also referred to herein as “scanning data”) from the tag 372. Put another way, it is determined which reader devices within the building 300 have read or are reading the tag 372. Alternatively or additionally, it is determined which scanning antennas attached to the reader devices within the building 300 have received or are receiving information from the tag 372. The scanning data, for example, may indicate that only reader devices 330, 332, and 334 have read or are currently reading (e.g., in real-time or in near-real-time) the target tag 372. Embodiments, can then lookup a configuration file or data structure (described in more detail below) to map the scanning data or specific active reader devices to a specific room. For example, a mapping may indicate that reader devices 330, 332, and 335 are all located in room 350. Accordingly, a prediction can be made that the target asset 370 is located in room 350. Certain embodiments can further deduce that because no scanning data is arising from any of the reader devices 340, 342, 344, and 346 (and that a mapping shows that these reader devices belong to room 352) that the target asset 370 is not located in room 352.

In some situations, reader devices from multiple rooms or geographical areas may indicate scanning data. For example, an indication may be received that both the reader device 340 (located in room 352) and the reader device 334 (located in room 350) have read data from the target tag 372. In these situations, some embodiments perform a voting algorithm functionality and/or use this anomaly or outlier data to determine the specific location of an asset. For example, the “voting algorithm functionality” may include calculating which room or other geographical area is associated with the most scanning data and the room or other geographical area that has the most scanning data “wins” or otherwise is selected to become the target prediction room or geographical area that the target asset is predicted to be located in. For example, the asset 370 may be located within the storage unit 308. The scanning data may indicate that reader devices 334, 336, 338 (located in room 350), and 340 (located in room 352) have read or are currently reading data from the target tag 372. Certain embodiments can then look up a configuration data structure or file to determine that 3 of the reader devices are located in room 350, and only 1 reader device is located on the room 352. Accordingly, because 3 is larger than 1 indicating that the asset 470 is more likely to be in room 350 relative to room 352, the room that wins the vote is room 350. Therefore, it can be determined that the asset 370 is in room 350 and not in room 352.

In some embodiments, weighting or specific values are used to determine more granular location sensing alternative to or in addition to the voting functionality described above. For example, one or more policies or rules may indicate that the lower the probability of a target tag being in a particular geographical area, the higher likelihood that the particular target tag is located along a wall or other structure that divides two or more geographical areas. In these embodiments, threshold values (e.g., integers, floats, or other real numbers as defined in conditional statements) can define the probability policies of target tags being in a particular geographical area. For example, a rule may indicate that if the probability of a target tag being in a first geographical area is less than 70% (and reader devices from other geographical areas are reading the target tag) then embodiments can determine that the particular storage unit that the target tag is in, is located along a wall or other structure within the first geographical area. In an illustrative example, the asset 370 may be located in storage unit 308 (which is in room 350). The reader devices 334, 336, and 338 (all within room 450) and reader devices 316 and 318 (within room 352) may indicate scanning data. The probability that the tag 372 is located in room 350 may be 60% (e.g., as calculated by dividing the total number of reader devices mapped to room 350 that have or are reading the tag 372 (which is 3) by the total number of reader devices in all of the rooms that have or are reading the tag 372 (which is 5). Likewise, the probability that the tag 372 is located in room 352 may be 40% (e.g., as calculated by dividing the total number of reader devices mapped to room 352 that have or are reading the tag 372 (which is 2) by the total number of reader devices in all of the rooms that have or are reading the tag 372 (which is 5).

Both of these probabilities 60% and 40% may be below a defined threshold (e.g., 70%), as indicated in one or more policies or rules. In some embodiments, in response to the determining that the probabilities are below the defined threshold, certain embodiments can determine that the tag 372 is within room 350 (because it has the higher probability percentage of 60%) but is likely close to or along the wall/divider 314 near room 352 because room 352 is within a certain probability threshold relative to room 350. Put another way, the percentages of 40% and 60% are relatively close (or likewise the 2 reader devices of room 352 reading the tag 372 is almost equal to the 3 reader devices of room 350 reading the same tag 372) and so it is likely that the tag 372 is practically in between the two rooms or along a structure or wall that divides the two rooms. In some embodiments, the logistics facility 300 represents a computer-readable map, data structure, and/or vector embedding such that embodiments can explicitly define portions of the building 300, such as the wall 314. In this way, embodiments can explicitly determine or predict that target tags are located along walls, ceilings, floors, and/or other structures in a building.

In some embodiments, responsive to predicting which room or other geographical area an asset is within, particular embodiments perform more granular location sensing. For example, some embodiments predict that the target asset 370 (or corresponding target tag 372) is located in the storage unit 304 (and not in any of the other storage units), which is described in more detail below. Additionally or alternatively, in some embodiments, in response to predicting that the target asset 370 is located in the storage unit 304, it is predicted where the asset's exact location within the storage unit 304 is, which is described in more detail below. For example, as illustrated in FIG. 3, the asset 370 is located in a very specific location to the immediate right of the environment tag 360-5. Predicting very granular locations of assets even within storage units themselves is beneficial for various reasons. For example, a storage unit may be extremely large and/or there may be multiple other assets within the storage unit and so it may be arduous or time consuming to locate an asset even if operators know that an asset is located in the storage unit.

### IV. Example Logistics Vehicle

FIG. 4 is a schematic diagram of an example logistics vehicle 414, according to some embodiments. In some embodiments, the logistics vehicle 414 represents the logistics vehicles 122, 132, 134, and/or 140 of FIG. 1. As such, for example, in some embodiments, the RFID reader 418 (and/or each of the antennas 420, 422, 424, and 426) represents the reader device 124 of FIG. 1 within the logistics vehicle 122. As illustrated in FIG. 4, the logistics vehicle 414 includes the array of assets 440 (including asset 440-1), the RFID reader device 418 coupled to (or build within) the sidewall 414-1 of the logistics vehicle 414, and four antennas—420, 422, 424, and 426—that are communicatively coupled to each other and the RFID reader device 418 via the common bus or communications link 430. The communications link 430 is a wired connection coupled to (or build within) the sidewall 414-1 of the logistics vehicle 414 and connects to each of the RFID antennas 420, 422, 324, and 424 so as to relay to readings to or from the RFID reader 418. It is understood, however, that a wired connection may not be required, but any suitable communication link can be established (e.g., BLUETOOTH) between antennas.

In some embodiments, one or more RFID antennas (e.g., RFID antenna 420) is a transceiver that is configured to both interrogate, by transmitting a signal to, one or more tags located with the asset array 440 and responsively receive, from a corresponding tag coupled to a respective asset, a corresponding tag ID (or other data). In some embodiments, however, one or more RFID antennas is only a receiver, which is configured to passively receive (and not transmit) RFID tag IDs or data from respective tags.

The RFID reader device 418 is configured to receive, via the communications link 430 and from each of the antennas 420, 422, 424, and 426, a respective RFID tag ID (and/or other data) and then read or decode such tag ID. For example, in response to the antenna 420 being within a communication range threshold (corresponding to a distance threshold) to the asset tag of the package 440-1, the tag coupled to the package 440-1 transmits, via a separate antenna, its ID to the RFID antenna 420. The RFID antenna 420 responsively transmits the tag ID through the communications link 430 to the RFID reader device 418, which then reads or decodes the tag ID.

As illustrated in FIG. 4, there are multiple antennas 420, 422, 424, and 426 that are evenly spaced out within the logistics vehicle 414 such that the RFID reader device 418 is able to capture signals from a tag coupled to an asset located in any position within the logistics vehicle 414. In other words, in some embodiments, any one given antenna has a transmitting and/or receiving range capacity for communicating with a tag relative to its specific position. For example, the antenna 426 may only be able to transmit an interrogation signal to areas that include the half of the logistics vehicle 414 that the antenna 426 is located in. Accordingly, the antenna 426 may not be able to transmit a signal to a tag coupled to the package 440-1. Therefore, particular embodiments additionally employ antennas 426, 424, and/or 422 so as to provide a greater transmission and/or receiving range for a wider lens of visualization within the logistics vehicle 414.

In some embodiments, in response to the RFID reader device 418 decoding or reading each tag ID or other tag data derived from a corresponding antenna, such as 420, the RFID reader device 418 transmits (e.g., via the antenna 426), over a network, the tag ID and its own ID, to a central server or other device (e.g., a cloud computing node), which then associates the tag ID to the corresponding package and RFID reader device 418 ID to the particular logistics vehicle 414. For example, a server may perform a lookup, at a data structure, of the RFID reader device 418 ID (a key in a key-value pair structure) to map its ID to an ID (a value in the key-value pair structure) of a logistics vehicle it belongs in. The server may additionally map the received tag ID to a corresponding package. Based on these mappings, the server infers that the package 440-1, for example, is located within the logistics vehicle 414. It is understood, however, that in some embodiments, such backend server functionality is alternatively performed at the RFID reader device 418 itself or other computing device local to or within the logistics vehicle 414.

### V. Example Sorting Facility

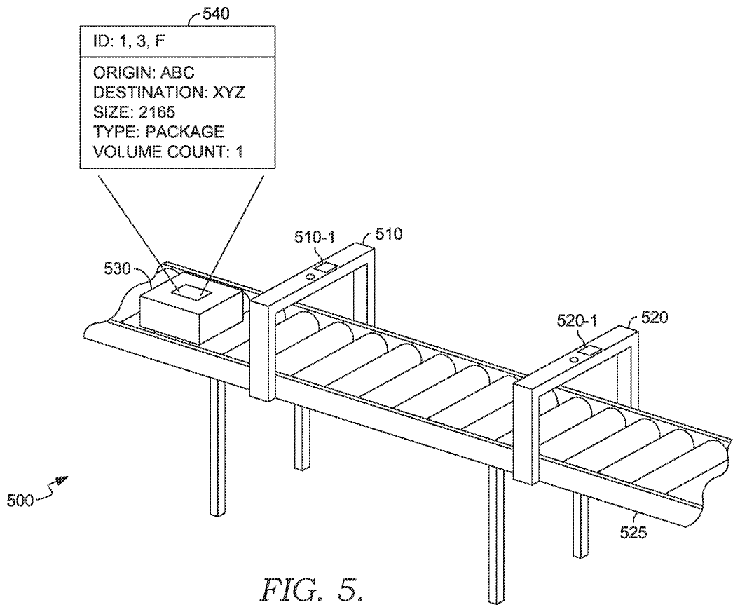

FIG. 5 is a schematic diagram of a sorting facility 500 illustrating how one or more assets may interact with various reader devices, according to some embodiments. In some embodiments, the sorting facility 500 represents the logistics spoke 125, the logistics hub 130, and/or the logistics hub 136 of FIG. 1. The sorting facility 500 includes a conveyer apparatus 525. The conveyor apparatus 525 includes a first base 510 that includes a first reader device 510-1, a second base 520 that includes reader component 520-1, and a parcel 530. The parcel 530 includes a tag 540 fixed or otherwise coupled to the parcel 530. The bases 510 and 520 provide a mechanical framework for physically orienting the corresponding reader devices 510-1 and 520-1 such that these reader devices can be in an optimal position to receive and read/decode data from the tag 540 without interference or disruption of the direction of flow of the corresponding assets. In some embodiments, the reader devices 510-1 and 520-1 are coupled to a bottom surface of the respective bases 510 and 520 (i.e., facing the conveyor apparatus 525) to provide an optimal read/decode environment.

The sorting facility 500 illustrates that the conveyer apparatus 525 may shift or move the parcel 530 from one position in the sorting facility 500 to another while receiving (as illustrated in FIG. 5) data from the tag 540. The conveyer apparatus 525 may automatically facilitate the movement of the parcel 530. In some embodiments, a “conveyor apparatus” as described herein includes any suitable conveyor belt assembly that includes a conveyor belt (continuous medium that carries assets from one location to another) one or more rollers or idlers that rotate the belt or rotate such that the parcels are moved, and/or one or more pulleys (e.g., located on the ends of the conveyor apparatus 525) that transmit drive power into the belt. A conveyor apparatus, however, need not require a “belt” but can use rollers or other mechanisms to move parcels. The conveyor apparatus 525 may include a rotating component (e.g., a belt or set of rollers) that is configured to cause movement of one or more assets for loading the one or more asset. In response to the rotating component causing movement of a parcel 530 past the first reader device 510-1 or relative to the second reader device 520-1, the first or second reader device 510 or 520 reads the tag 540 of the parcel 530, which may be then transmitted over network(s) 110 (as described in FIG. 1 and FIG. 2). In other words, in response to the tag 540 being within a communication range of the reader device 510-1 and/or 520-1, the tag 540 transmits the corresponding data (i.e., its ID, the asset 530's destination, size of the asset 530, and/or the type of asset) to the respective reader device 510-1 and/or 520-1.

Although the first reader device 510-1 is illustrated as being attached or a part of the conveyor apparatus 525, it is understood that the first reader device 510-1 or any other component that reads tags does not have to be attached to a conveyor apparatus 425 and can be oriented in any suitable position (e.g., on a ceiling, floor, or be stand-alone) and can take on any suitable form (e.g., a sphere or triangle) or any other configuration besides what is illustrated in FIG. 5.

The tag 540 may include specific identifiers and values, such as destination (e.g., address where the parcel 530 is delivered to), size (e.g., weight or dimensions (e.g., length, width, height)), and type (e.g., smalls, drum, box). It is understood that this is representative and that any identifier or values associated with a corresponding parcel 530 can alternatively or additionally be stored to any tag. For example, the tag 540 may alternatively or additionally include other attributes or identifiers, such as: shipper name, fragileness of the parcel 530, the level of security associated with the parcel 530 (e.g., high security parcels 530 may be sorted to a particular logistics vehicle, described below), indications of whether the shipment is expedited, zip code, whether the parcel 530 is domestic or foreign, etc. Some or each of these identifiers can be used to sort the parcel 530 as described herein.

As the first reader device 510-1 and/or second reader device 520-1 identify tags such as tag 540 as they move along the conveyer apparats 525, the information received may not only include information from the tag 440, but also include indications of the tag 540 position. In some embodiment, the second reader component 520 may receive an indication of the tag 540 position based on a relative location of the second reader component 520 to the tag 540. For example, the second reader component 520 may receive the indication of the tag 540 position based on the signal strength received from the tag 540. In some embodiments, the signal strength may be stronger when received by the second reader component 520 when the tag 540 is closer to the second reader component 540 than when the second reader component 520 is further from the tag 540. In other words, in these embodiments, the signal strength is directly proportional to the location of an asset. The higher the signal strength between reader device and tag 540, the more likely that the parcel 530 is near that reader device.

In some embodiments, in response to the reader device 510-1 and/or 520-1-reading or decoding data from the tag 540, the respective reader devices 510-1 and/or 520 transmit, over the network(s) 110, the data stored to the tag as well as an identifier that identifies the respective reader device. In this way, for example, the analysis computing entity 05 can associate (e.g., via a lookup data structure) the identifier representing the particular reader device to a location within the sorting facility 500. For example, a data structure may be a hash map with a column representing an ID of a reader device and a second column representing the geographical area the reader device is in. In this way, for example, the ID received from the respective reader device can be used as a key to map it to the corresponding ID in a data structure and a particular location within the sorting facility. Responsively, the analysis computing entity 05 infers or predicts that the asset 530 is in the respective geographical location within the particular sorting facility 500.

### VI. Example Logistics Environment

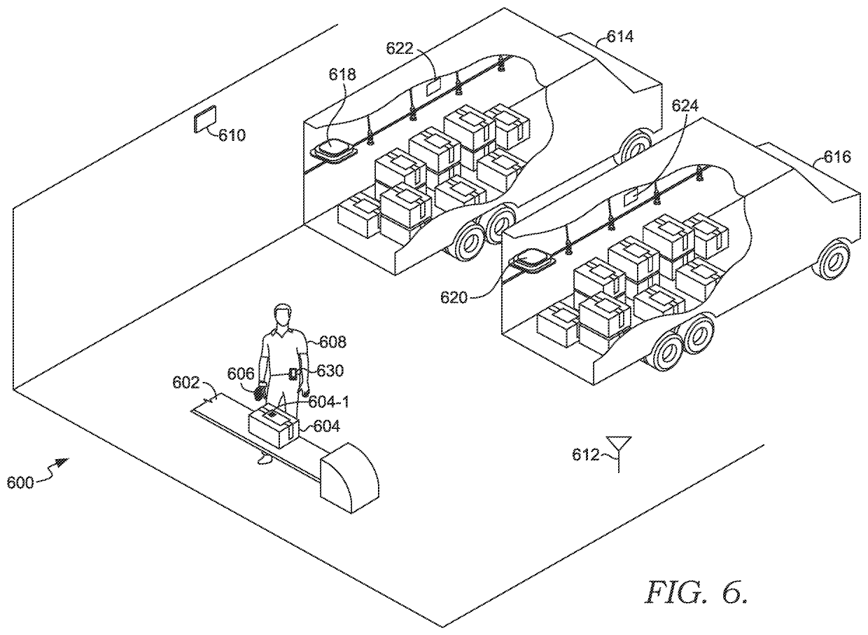

FIG. 6 is a schematic diagram of an example tag-reader environment for detecting and following a location of the asset 604 from the conveyor belt assembly 602 to its loading within the logistics vehicle 614, according to some embodiments. In some embodiments, the environment represents the logistics hub 130, logistics hub 136, and/or the logistics spoke 125. In some embodiments, the conveyor apparatus 602 represents the conveyor apparatus 525 of FIG. 6. In some embodiments, the logistics vehicles 614 and/or 616 represent the logistics vehicles 122, 132, 140, 134 of FIG. 1, and/or the logistics vehicle 414 of FIG. 4. The environment 600 includes a conveyor apparatus 602, a package 604 (which includes a tag 604-1), a loading user 608 that is wearing a reader device 606 and is carrying a mobile device 630 (e.g., a smart phone), one or more reference tags 610, one or more reader devices 612, and two logistics vehicles 614 and 616, each of which has one or more corresponding reference tags and/or reader devices 622 and 624.

At a first time, in response to an antenna of the wearable reader device 606 (e.g., an arm band with an embedded reader device) being within a signal (e.g., RSSI) strength threshold, communication range threshold (e.g., the ability of the antenna to receive a signal from a tag where the tag is active), and/or distance threshold of the tag 604-1 (indicative of the loader 608 approaching the asset 604 to pick it up or the conveyor 602 pushing the asset 604 close to the loader 608), the wearable reader device 606 receives and reads data from the tag 604-1. In response to the reader device 606 reading the data from the tag 604, some embodiments access, over a computer network, a data structure that indicates that the parcel 604 is assigned to be placed inside the logistics vehicle 614 (and not the logistics vehicle 616). For example, in some embodiments, this includes receiving a tag ID or other tag data from the tag 604-1 in response to the reading and then calling a lookup table data structure to map the tag ID to the package (i.e., 604) it is coupled to and then looking up the same or different data structure (e.g., a helper data structure) to map the package ID to the vehicle ID that the package 604 is supposed to be loaded in.

In response to such mapping and access of the data structure(s), some embodiments, guide the loader 608 to the logistics vehicle 614 via the mobile device 630 and/or the wearable user device 606. For example, some embodiments open a communication channel with loader 608's mobile device 630 (by mapping, via a data structure, the ID of the reader device 606 to an IP or MAC address of the mobile device 630) and cause a notification to be displayed, which displays an identifier identifying the correct logistics vehicle 614 that the loader 608 is supposed to load the package 604 into and/or an electronic map illustrating where the logistics vehicle 614 is. In another example, some embodiments open a communication channel with the wearable reader 606 itself and cause auditory signals (e.g., natural language directions), LED's, etc. to identify the correct logistics vehicle.

Some embodiments provide near real-time feedback to the wearable reader device 606 and/or mobile device 630 to guide the operator 608 to the logistics vehicle 614 via the reader device 606, the reference tag(s) 610, the reader device(s) 612, the reference tag(s) 612, the reader device 618, the reference tag(s) 624, and/or the reader device 620. For example, in some embodiments, each of the reference tag(s) 610 is generally responsible for indicating or emitting/transmitting data (e.g., to the wearable reader device 630), such as an identifier that identifies the respective tag, which can be used to predict the general location of the wearable reader device 606 (or more generally the asset 640 by inference since the loader is presumable carrying the asset 604). For example, in response to the wearable reader device 606 being within a signal strength or communication range one of the tag(s) 610 (because the operator 608 is walking past that area), the wearable reader device 606 receives and reads one of the tags 610. Responsively, particular embodiments map (e.g., via a lookup data structure) the respective tag(s) 610 an environment ID (e.g., an area within a hub) that the tag(s) 610 is located in. Responsively, particular embodiments can infer that the loader 608 (or associated tag 604-1), for example, is in the corresponding environment and is heading toward the correct logistics vehicle 614. Responsively, particular embodiments, for example, cause display of feedback to the mobile device 630, such as “keep walking in that direction,” or “move south immediately, you are heading towards the wrong logistics vehicle.”

In another example, indications that a subset of specific reader devices 612 are reading data from the tag 604-1 can indicate that the tag 604-1 is located in a particular geographical area (e.g., a particular room or section of a building) based on a predefined mapping data structure that associates each reader device with a room. The tag(s) 610 and/or reader device(s) 612 are placed in any suitable physical environment, geographical area, and/or apparatus (e.g., the conveyor 602) within such physical environment or geographical area. The tag(s) 610 and/or the reader device(s) 612 can be coupled to or placed in any suitable location, such as on the ceiling of a building in a logistics facility, on the floor of the building, on the walls of a building, and/or any structure, position, or orientation within a geographical area.

Some embodiments additionally determine or detect whether the package 604 is inside the logistics vehicle 614 and/or 616 via the use of the wearable reader device 606, the tag 604-12, the reference tag(s) 622, the reader device 618, the reference tag(s) 624, and/or the reader device 620. For example, in response to receiving an indication that the reader device 618 is within a signal strength, communication range, and/or distance threshold to the tag 604-1, the reader device 618 receives and reads data from the tag 604-1. In response to receiving an indication of this read, or the receipt of the tag ID of 604-1 (and/or other tag data), particular embodiments detect that the package 604 is inside the logistics vehicle 614 (since the package 604 is mapped, via a data structure, to the ID of the tag 604-1) and store, in computer memory or as a data record (e.g., a database row), data indicating that such package 604 has been loaded into the correct logistics vehicle 614.

In some embodiments, the reference tag(s) 622 is additionally or alternatively used to make the same inference that the package 604 is located inside the logistics vehicle 614. For example, in response to the wearable reader device 606 being within a signal strength, communication range, and/or distance threshold to the tag(s) 622 (presumably because the loader 608 has loaded or is inside the logistics vehicle 614 loading the package 604), the reader device 606 reads data from the tag(s) 622. In response to receiving an indication of this read of the tag ID(s) (and/or other tag data) of 622, particular embodiments detect that the package 604 is inside the logistics vehicle 614 (since the tag(s) 622 are mapped, via a data structure, to the logistics vehicle 614 and the wearable reader device 606 is mapped to the package 604 based on the wearable device 606 reading the tag 604-1) and store, in computer memory or as a data record (e.g., a database row), data indicating that such package 604 has been loaded into the correct logistics vehicle 614.

In some instances, the wearable reader device 606 reads data from some of the reference tags 622 and 624 inside both logistics vehicles 614 and 616 (and/or some of the tag(s) 610). In these instances, some embodiments perform an arithmetic algorithm to detect the quantity of reads of either logistics vehicles (or other areas outside of the logistics vehicles), compare the quantities, and the logistics vehicle (or area) with the highest quantity of tag reads is predicted to be the logistics vehicle (or area) that the package 604 is located in. For example, the wearable reader device 606 may read 10 tags inside the logistics vehicle 614, but only 5 tags inside the logistics vehicle 616. Because 10 is higher than 5, the package 605 is predicted to be located in the logistics vehicle 614. In some embodiments, signal strength between the wearable reader device 606 and the tags(s) 622 and 624 is alternatively or additionally used. In these embodiments, the signal strength is compared between readings of each vehicle and it is predicted that the package 604 is inside a particular logistics vehicle based on the highest signal strength between the wearable reader device 606 and the respective tag(s) 622 and 624 of the respective vehicles 614 and 616.

In a similar situation, in some instances, the reader devices 618 and 620 (and/or 612) will both read the data from the tag 604-1. In these instances, some embodiments perform arithmetic to detect the quantity of reads of both logistics vehicles, compare the quantities, and the logistics vehicle with the highest quantity of tag reads is predicted to be the logistics vehicle that the package 604 is located in. For example, the logistics vehicle 614 may have 10 reader devices 618 that read the tag 604-1, whereas the logistics vehicle 616 has 5 reader devices 620 that read the tag 604-1. Because 10 is higher than 5, the package 604 is predicted to be located in the logistics vehicle 614. In some embodiments, signal strength between the reader device 618/reader device 620 and the tags 604-1 is alternatively or additionally used. In these embodiments, the signal strength is compared between readings of each vehicle and it is predicted that the package 604 is inside a particular logistics vehicle based on the highest signal strength between the reader device 618 and tag 604-1 and the reader device 620 and the tag 604-1.

As has been described herein, particular embodiments generate and derive one or more data structures that provide mappings in order to know which reader devices and/or tags belong to which environment (e.g., specific geo-coordinates in a hub or in a specific logistics vehicle). Such data structures can additionally provide mappings in order to know which user devices (e.g., mobile device 630) belong to which users, and which tags are coupled to which assets. Such data structures can be or include any suitable data structure, such as a lookup table, a hash map, a list, or the like. In an illustrative example, a lookup table or hash map may include a key column that lists each ID of each logistics vehicle. And for each ID, there is a list of other tag IDs representing each tag that is coupled to a particular logistics vehicle.

### VII. Example Computer Model

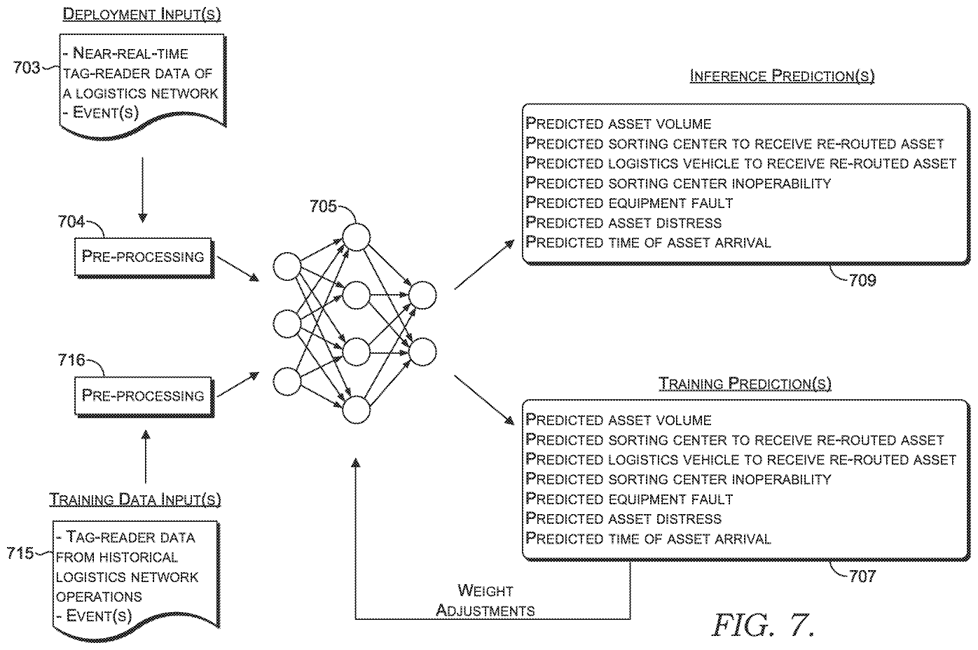

FIG. 7 is a schematic diagram illustrating how a neural network 705 makes particular training and deployment predictions given specific inputs, according to some embodiments. In one or more embodiments, the neural network 705 represents or includes at least some of the functionality as described with respect to the logistics network prediction component 217 of FIG. 1. In some embodiments, the neural network 705 represents or includes alternative or additional model functionality, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

In some embodiments, the neural network 705, as illustrated in FIG. 7, has multiple input nodes (input layer), hidden nodes, and multiple output nodes (an output layer), where each node represents an input variable or feature (e.g., RFID read present/not present, ID of reader device/tag of the read, timestamp of read, or other data stored to a tag) and where each node comprises a linear/non-linear function and an activation function. Every node in one layer is connected to every other node in the next layer. A given node typically takes the weighted sum of its inputs, and passes it through an activation function (e.g., a dot product vector). This is the output of the node, which then becomes the input of another node in the next layer. The signal flows from left to right, and the final output is calculated by performing this procedure for all the nodes. Training a neural network typically means learning the weights associated with all the edges (the lines connecting the nodes). The input features (x) are typically fed into the linear/non-linear function of each node, resulting in a value, z. Then, the value z is fed into the activation function, which determines if a node is activated or inhibited (e.g., between 0 and 1). Thus, each node ultimately determines which nodes in the following layer get activated, until it reaches an output.

In some embodiments, before the training data input(s) 715 (or the deployment input(s) 704) are provided as input into the neural network 705, the inputs are preprocessed at 716 (or 704). In some embodiments, such pre-processing includes data wrangling, data munging, scaling, and the like. Data wrangling and data munging refers to the process of transforming and mapping data from one form (e.g., “raw”) into another format with to make it more appropriate and useable for downstream processes (e.g., predictions 707). Scaling (or “feature scaling”) is the process of changing number values (e.g., via normalization or standardization) so that a model can better process information. For example, some embodiments can bind number values between 0 and 1 via normalization. Other examples of preprocessing includes feature extraction, handling missing data, feature scaling, and feature selection.

Feature extraction involves computing a reduced set of values from a high-dimensional signal capable of summarizing most of the information contained in the signal. Feature extraction techniques develop a transformation of the input space onto the low-dimensional subspace that attempts to preserve the most relevant information. In feature selection, input dimensions that contain the most relevant information for solving a particular problem are selected. These methods aim to improve performance, such as estimated accuracy, visualization, and comprehensibility. An advantage of feature selection is that important information related to a single feature is not lost, but if a small set of features is required and original features are very diverse, there is chance of information being lost as some of the features must be omitted. On the other hand, with dimensionality reduction, also known as feature extraction, the size of the feature space can often be decreased without losing information about the original feature space.

In some embodiments, these feature extraction techniques include, but are not limited to Minimum Redundancy Maximum Relevance (“mRmR”), Relief, Conditional Mutual Information Maximization (“CMIM”), Correlation Coefficient, Between-Within Ratio (“BW-ratio”), Interact, Genetic Algorithms (“GA”), Support Vector Machine-Recursive Feature Elimination (“SVM-REF”), Principal Component Analysis (“PCA”), Non-Linear Principal Component Analysis, Independent Component Analysis, and Correlation based feature selection. These feature extraction techniques are useful for machine learning because they can reduce the complexity of input data and give a simple representation of data representing each variable in feature space as a linear combination of the original input variable.

In some embodiments, the pre-processing of the data at 716 and/or 704 includes missing data techniques. In some embodiments, these missing data techniques include complete case analysis, single imputation, log-linear models and estimation using the EM algorithm, propensity score matching, and multiple imputations. The technique confines attention to cases for which all variables are observed in a complete case analysis. In a single implicit imputation method, missing values are replaced by values from similar responding units in the sample. The similarity is determined by looking at variables observed for both respondent and non-respondent data. Multiple imputations replace each missing value with a vector of at least two imputed values from at least two draws. These draws typically come from stochastic imputation procedures. In the log linear model, cell counts of a contingency table are modeled directly. An assumption can be that, given expected values for each cell, the cell counts follow independent multivariate Poisson distributions. These are conditional on the total sample size, with the counts following a multinomial distribution.

In some embodiments, the preprocessing at 716 and/or 704 includes outlier detection and correction techniques for handling outlier data within the input data 715/703. Outliers, by virtue of being different from other cases, usually exert a disproportionate influence on substantive conclusions regarding relationships among variables. An outlier can be defined as a data point that deviates markedly from other data points.

For example, error outliers are data points that lie at a distance from other data points because they result from inaccuracies. More specifically, error outliers include outlying observations that are caused by not being part of the targeted population of data, lying outside the possible range of values, errors in observation, errors in recording, errors in preparing data, errors in computation, errors in coding, or errors in data manipulation. These error outliers can be handled by adjusting the data points to correct their values or more such data points from the data set. In some implementations, particular embodiments define values more than three scaled median absolute deviations (“MAD”) away from the median as outliers. Once defined as an outlier, some embodiments replace the values with threshold values used in outlier detection.

In some embodiments, the preprocessing at 716 and/or 704 includes feature scaling 115 on the input(s) 716 and/or 704 as part of the data preprocessing process. Feature scaling is a method to unify self-variables or feature ranges in data. In some embodiments, feature scaling is a necessary step in the calculation of stochastic gradient descent. Particular embodiments can perform various feature scaling techniques. In some embodiments, these feature scaling techniques include, but are not limited to, data normalization methods and interval scaling.

In some embodiments, preprocessing at 716 and/or 704 includes data normalization. Data normalization is a basic work of data mining. Different evaluation indicators often have different dimensions, and the difference in numerical values may be very large. Without processing, the results of data analysis may be affected. Standardized processing is needed in order to eliminate the influence of dimension and range differences between indicators. The data is scaled to a specific area to facilitate comprehensive analysis. The premise of the normalization method is that the eigenvalues obey the normal distribution, and each genus is transformed into a standard positive distribution with a mean of 0 and a variance of 1 by translation and scaling data transformation. The interval method utilizes the boundary information to scale the range of features to a range of features. For example, the commonly used interval scaling methods such as [0, 1] use two extreme values (maximum and minimum values) for scaling.

In some embodiments, the preprocessing at 716 and/or 704 includes feature selection at the input data 715 and/or 703. Feature selection techniques can be performed for dimensionality reduction from the extracted features. The feature selection techniques can be used to reduce the computational cost of modeling, to achieve a better generalized, high-performance model that is simple and easy to understand. Feature extraction techniques can be performed to reduce the input data's dimensionality. However, in some implementations, the resulting number of features may still be higher than the number of training data 715. Therefore, further reduction in the dimensionality of the data can be performed using feature selection techniques to identify relevant features for classification and regression. Feature selection techniques can reduce the computational cost of modeling, prevent the generation of a complex and over-fitted model with high generalization error, and generate a high-performance model that is simple and easy to understand. Some embodiments use the mRmR sequential feature selection algorithm to perform feature selection 116. The mRmR method is designed to drop redundant features, which can design a compact and efficient machine learning-based model.

After preprocessing at 716, in various embodiments, the neural network 705 is trained using one or more data sets of the preprocessed training data input(s) 715 in order to make acceptable loss training prediction(s) 707 at the appropriate weights, which will help later at deployment time to make correct inference prediction(s) 709. In one or more embodiments, learning or training includes minimizing a loss function between the target variable (for example, an incorrect prediction that shipping volume should be re-routed to sorting facility X) and the actual predicted variable (for example, a correct prediction that the shipping volume should be re-routed to sorting facility Y). Based on the loss determined by a loss function (for example, Mean Squared Error Loss (MSEL), cross-entropy loss, etc.), the loss function learns to reduce the error in prediction over multiple epochs or training sessions so that the neural network 705 learns which features and weights are indicative of the correct inferences, given the inputs. Accordingly, it is desirable to arrive as close to 100% confidence in a particular classification or inference as close as possible so as to reduce the prediction error. In an illustrative example, the neural network 705 learns over several epochs that for a given set of historical tag-reader data or event (e.g., a hurricane in location X), the assets should be re-routed from hub A to hub B.

Subsequent to a first round/epoch of training, the neural network 705 makes predictions with a particular weight value, which may or may not be at acceptable loss function levels. For example, the neural network 705 may process the pre-processed training data input(s) 715 a second time to make another pass of prediction(s) 707. This process may then be repeated over multiple iterations or epochs until the weight values are set for optimal or correct predicted value(s) is learned (for example, by maximizing rewards and minimizing losses) and/or the loss function reduces the error in prediction to acceptable levels of confidence.

In one or more embodiments, the neural network 705 converts or encodes the runtime deployment input(s) 703 and training data input(s) 715 into corresponding feature vectors in feature space (for example, via a convolutional layer(s)). A “feature vector” (also referred to as a “vector”) as described herein may include one or more real numbers, such as a series of floating values or integers (for example, [0, 1, 0, 0]) that represent one or more other real numbers, a natural language (for example, English) word and/or other character sequence (for example, a symbol (for example, @, !, #), a phrase, and/or sentence, etc.). Such natural language words and/or character sequences correspond to the set of features and are encoded or converted into corresponding feature vectors so that computers can process the corresponding extracted features. For example, embodiments can parse, tokenize, and encode each value or other content in pages into one or more feature vectors.

In some embodiments, such as in clustering techniques, the neural network 705 learns, via training, parameters, or weights so that similar features are closer (for example, via Euclidian or cosine distance) to each other in feature space by minimizing a loss via a loss function (for example, Triplet loss or GE2E loss). Such training occurs based on one or more of the preprocessed training data input(s) 715, which are fed to the neural network 705.

One or more embodiments determine one or more feature vectors representing the input(s) 615 in vector space by aggregating (for example, mean/median or dot product) the feature vector values to arrive at a particular point in feature space. For example, certain embodiments formulate a dot product of all tag-reader modulations (e.g., tag reads, absence of tag reads, metadata associated therewith (e.g., timestamps), RSSI signal strength values) at sorting facility X representing a particular time period (e.g., 1 year) and then aggregates these values into a single feature vector.

In one or more embodiments, the neural network 705 learns features from the training data input(s) 715 and responsively applies weights to them during training. A “weight” in the context of machine learning may represent the importance or significance of a feature or feature value for prediction. For example, each feature may be associated with an integer or other real number where the higher the real number, the more significant the feature is for its prediction. In one or more embodiments, a weight in a neural network or other machine learning application can represent the strength of a connection between nodes or neurons from one layer (an input) to the next layer (a hidden or output layer). A weight of 0 may mean that the input will not change the output, whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores.

In another illustrative example of training, one or more embodiments learn an embedding of feature vectors based on learning (for example, deep learning) to detect similar features between training data input(s) 715 in feature space using distance measures, such as cosine (or Euclidian) distance. For example, the training data input 715 is converted from string or other form into a vector (for example, a set of real numbers) where each value or set of values represents the individual features (for example, individual tag-reader data values (e.g., X reader read Y tag at Y time) in feature space. Feature space (or vector space) may include a collection of feature vectors that are each oriented or embedded in space based on an aggregate similarity of features of the feature vector. Over various training stages or epochs, certain feature characteristics for each target prediction can be learned or weighted. For example, for a first sorting center, the neural network 705 can learn that the first sorting center processing a range of assets between A and B over 90% of the time (i.e., the shipping volume). Consequently, this pattern can be weighted (for example, a node connection is strengthened to a value close to 1), whereas other node connections (for example, representing other volume predictions between C and D are weakened to a value closer to 0). In this way, embodiments learn weights corresponding to different features such that similar features found in inputs contribute positively for predictions.

In some embodiments, such training is supervised using annotations or labels. Alternatively or additionally, in some embodiments, such training is not-supervised using annotations or labels but can, for example, include clustering different unknown clusters of data points together. For example, in some embodiments, training includes (or is preceded by) annotating/labeling tag-reader training data 715 so that the neural network 705 learns the features (e.g., timeliness, volume quantity), which is used to change the weights/neural node connections for future predictions. For example, the neural network 705 may learn that historically when sorting facility Y became inoperable, sorting facility Z was used to re-route assets that have particular attributes Z (e.g., a particular destination or origin). As such, the neural network 705 accordingly adjusts the weights or deactivates nodes such that sorting facility B, for example, is not as strong of a signal to use for re-routing the assets that have particular common attributes given the historical data.

In one or more embodiments, subsequent to the neural network 705 training, the neural network 705 (for example, in a deployed state) receives one or more of the pre-processed deployment input(s) 603. When a machine learning model is deployed, it has typically been trained, tested, and packaged so that it can process data it has never processed. Responsively, in one or more embodiments, the deployment input(s) 703 are automatically converted to one or more feature vectors and mapped in the same feature space as vector(s) representing the training data input(s) 715 and/or training predictions(s) 707. Responsively, one or more embodiments determine a distance (for example, a Euclidian distance) between the one or more feature vectors and other vectors representing the training data input(s) 715 or predictions, which is used to generate one or more of the inference prediction(s) 609. In some embodiments, the preprocessed deployment input(s) 603 are fed to the layers of neurons o

In an illustrative example, referring back to FIG. 1, the neural network 705 receives near-real-time tag-reader data (e.g., an indication that X reader devices read Y tag at S timestamps) from the logistics vehicle 122, the logistics spoke 125, and/or the logistics hub 130 of the logistics network 100. The neural network 705 then determines a distance (for example, a Euclidian distance) between the vector representing the runtime deployment input(s) 703 and the training data input(s) 715, where the input(s) 703 are passed through the same activated/deactivated nodes. Based on the distance being within a threshold distance, particular embodiments generate a score at inference prediction(s) 709, such as a predicted asset quantity (volume) that will arrive at logistics hub 136, a predicted sorting center (e.g., sorting center 136) to receive a re-routed asset, a predicted logistics vehicle to receive a re-routed asset, predicted sorting center interoperability, predicted asset distress, and/or a predicted time of asset arrival. In another example, the preprocessed deployment input(s) 703 are run through the neural network 705, where the weights have been learned such that the input(s) 703 are mapped, for example, via a classifier or regression component, to the correct class or prediction (e.g., a predicted sorting center to route assets to).

In certain embodiments, the inference prediction(s) 709 may either be hard (for example, membership of a class is a binary “yes” or “no”) or soft (for example, there is a probability or likelihood attached to the labels). Alternatively or additionally, transfer learning may occur. Transfer learning is the concept of re-utilizing a pre-trained model for a new related problem (for example, a new video encoder, new feedback, etc.).

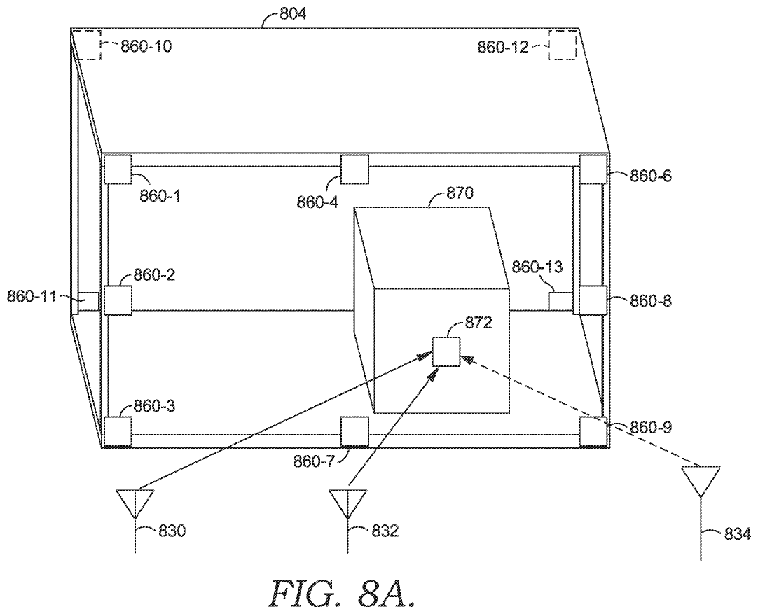

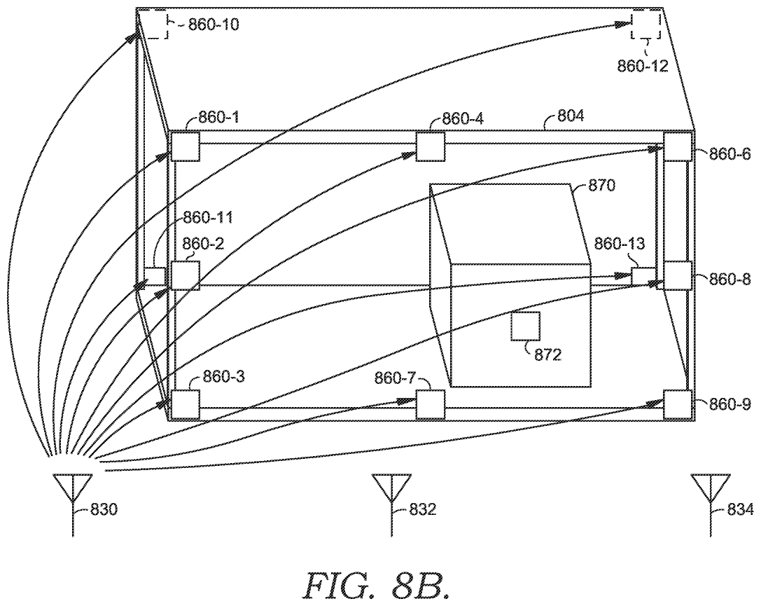

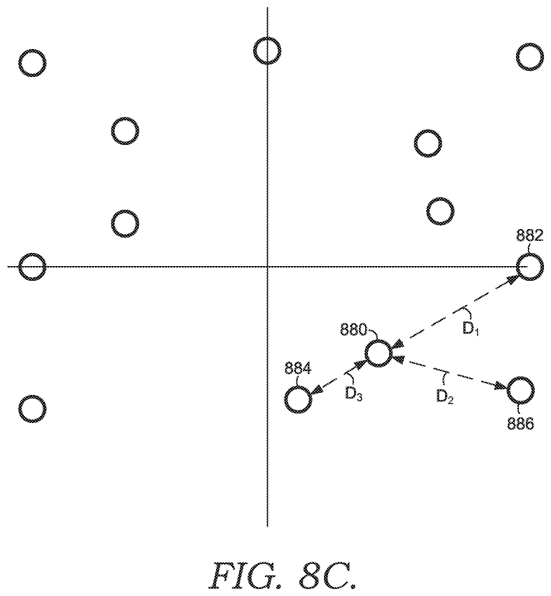

FIG. 8A is a schematic diagram of a storage unit that illustrates which particular storage unit an asset is predicted to be located in and/or where an asset's exact location within the storage unit is, according to some embodiments. In some embodiments, storage unit 404 represents any suitable storage unit (e.g., 304 of FIG. 3) or can be included in any logistics vehicle described herein, such as logistics vehicle 414 of FIG. 4. Some embodiments use a mapping and/or similar data structures to predict that the asset 870 is located within storage unit 804 (and not in other storage units) based on the proportion of antennas mapped to the storage unit 804 that are actually scanning or have scanned (e.g., for a particular time window) the asset 870. This is to say that some embodiments determine which antennas (or reader devices) has received data from the tag 872 and then mapping those reader antennas to the storage unit 804. In an illustrative example, the following algorithm can be performed for the asset 470 needing to be located. During a time window X or in near-real-time, certain embodiments extract all scanning data for the asset 870 and place them into SCANS (i.e., antennas 830 and 832 are the only antennas that have received or are currently receiving data from tag 872. Then, particular embodiments calculate the unique list of antenna values (e.g., antenna or reader device IDs) present in SCANS. Mappings may then be used to determine which storage IDs are assigned to the unique antennas (i.e., all antennas 830, 832, and 834 are mapped to storage unit 804). For storage unit 804, embodiments calculate SIGNAL_PROPORTION as the percentage of antennas mapped to the storage unit 804, which are present in SCANS. For example, reader devices 830, 832, and 834 are mapped to storage unit 804, and asset 870 has scanning data for only antenna 830 and 832, then target asset 870 has a SIGNAL_PROPORTION of 0.66. Put another way, 2 of the 3 antennas (830 and 832) that are mapped to storage unit 804 are actually present in the scanning data (have received or are currently receiving the tag ID) whereas one of the antennas (i.e., 834) mapped to the storage unit 804 is not present in the scanning data and so 2 divided by 3 is 0.66, representing the proportion or percentage of antennas mapped to a given storage unit that are actually scanning (reading) or have scanned the tag 872. Accordingly, embodiments determine whether all antennas defined in the configuration file or mapping that are mapped to the storage unit 804 are actually receiving or have received data from the tag 872. If all of the antennas 830, 832, and 834 that are mapped to storage unit 840 would have read the target tag 872, this represents the highest proportion or score. Conversely, if none of the antennas 830, 832, or 834 that are mapped to the storage unit 804 would have read the tag 872, this represents the lowest proportion or score.

In an illustrative example, the following algorithm or first pseudocode sequence can be performed for each target asset needing to be located. During a time window X or in near-real-time, certain embodiments extract all scanning data for each target asset and place them into SCANS. Then, particular embodiments calculate the unique list of reader device values (e.g., reader device IDs) present in SCANS. Responsively, some embodiments use the configuration file to identify all unique reader devices that are currently reading or have read the asset(s). Mappings may then be used to determine which storage IDs are mapped to the unique reader devices. Continuing with the first pseudocode sequence, for each storage unit, embodiments calculate SIGNAL_PROPORTION as the percentage or proportion of reader devices mapped to that storage unit which are present in SCANS. For example, if reader devices A, B, and C are mapped to shelf 1 (e.g., as indicated in a data structure), and package X has scanning data for Antenna A, C, and Q, then package X has a SIGNAL_PROPORTION of 0.66. Put another way, 2 of the 3 reader devices that are mapped to shelf 1 are actually present in the scanning data (have read or are currently reading the target tag) and so 2 divided by 3 is 0.66, representing the proportion or percentage of reader devices mapped to a given shelf that are actually scanning or have scanned a particular target tag. Accordingly, embodiments determine whether all reader devices defined in the configuration file or mapping that are mapped to a given storage unit are actually reading or have read a target tag. If all the reader devices mapped to a particular storage unit are indeed reading or have read the target tag, this represents the highest proportion or score. Conversely, if none of the reader devices that are mapped to a particular storage unit are reading the target tag, this represents the lowest proportion or score. In some embodiments, responsive to calculating the SIGNAL_PROPORTION, the storage unit with the highest SIGNAL_PROPORTION is identified and returned or determined to be the predicted storage unit that the target asset is located in.

In some embodiments, FIG. 8A also represents a prediction of the asset 870's precise location within the storage unit 804 (not just an indication that the asset 870 is within the storage unit 804, as described above). In some embodiments, predicting the precise location of the asset 870 within the storage unit 804 is based on comparing the signal strength (or indication of signal strength, such as power) between each antenna that is mapped to the storage unit 804 and the tag 872 with the signal strength or indication between each antenna mapped to the storage unit 804 and each reference tag attached to the storage device 804 (i.e., reference tags 860-1, 860-2, 860-3, 860-4, 860-6, 860-7, 860-8, 860-9, 860-10, 860-11, 860-12 and 860-13 (collectively referred to herein as the “reference tags 860”). In some embodiments, this occurs via a second pseudocode sequence. Extract all scanning data for the target asset 870 into SCANS (i.e., determine that antennas 830 and 832 have or are currently receiving data from the tag 872), which is illustrated in FIG. 8A.

Continuing with the second pseudocode sequence, responsively, certain embodiments extract all scanning data for all reference tags coupled to the storage unit 804 that the asset 870 is within (e.g., because it was already determined that the target asset 870 is within the storage unit 804), as illustrated in FIG. 8B, for example. In some embodiments, the scanning data (or any scanning data described herein) or SCANS includes signal strength readings (or indications of signal strength readings) (e.g., −75 dB, −80 dB, or any RSSI or other signal strength standard value) between a particular antenna and environment tag/target tag. FIG. 8B is a schematic diagram of the storage unit 804 of FIG. 8A, which that illustrates how to predict or detect an asset's (or tag coupled to the asset's) exact location within a storage unit, according to some embodiments. Specifically, FIG. 8B illustrates that scanning data (e.g., signal strength values) is extracted between each of the reference tags 860 and the antenna 830. In various embodiments, the same process is repeated for both of the antennas 832 and 834 (i.e., scanning data is extracted between each of the reference tags 860 and each antenna 832 and 834). Continuing with description of the second pseudocode example algorithm, the unique reader device IDs present in SCANS are found and stored as ANTENNAS. Likewise, the unique reference tag IDS present in TAG_SCANS are found and stored as TAGS.

Continuing with the second pseudocode example, for each antenna in ANTENNAS: find the mean of signal strengths from the scanning data in SCANS. Subtract this average from the max possible signal strength, then divide by the max to generate a normalized distance. This is the saved in the PACKAGE_DISTANCES. In an illustrative example of this using FIG. 8A, if a user selected a time window of 5 minutes, and the signal strength value between the antenna 830 and the asset tag 872 within the 5 minute window was −75 dB, −80 dB, and −77 dB, embodiments calculate the average ((75+80+77)/3=−77.3 dB). In various embodiments, the “max possible signal strength” is the highest scan or signal strength within the time window, which in this example is −80 dB. Accordingly, 77.3 is subtracted from 80 to arrive at 2.7. Dividing by the max may include dividing 2.7 by 80, to arrive at 0.034 to generate a normalized distance, which is saved into PACKAGE_DISTANCES. This process is repeated for each antenna/reader device mapped to the storage unit where the asset tag has been predicted to be within. For example, using the illustration above, signal strength values between antennas of the antennas 832 and 834 and the same tag 872 can also be normalized as described above. In this way, based on the signal strengths values, it is determined whether the asset tag 872 is relatively close or farther away from a particular antenna of a reader device (e.g., 830) relative to the distance between other antennas (e.g., 832 and 834). In these embodiments, signal strength or indications of signal strength is converted to distance metrics to determine how

Continuing with the second pseudo code example, for each tag in TAGS: and for each antenna (of each reader device) in ANTENNAS: determine the mean of signal strengths from the scans in TAG_SCANS. Subtract this average from the max possible signal strength, then divide by the max to generate a normalized distance. Save this into TAG_DISTANCES. In an illustrative example of this using FIG. 8B, if a user selected a time window of 5 minutes, and the signal strength value between the antenna 830 and reference tag 860-3 within the 5 minute window was −60 dB, −65 dB, and −61 dB, embodiments calculate the average ((60+65+61)/3=−62 dB). In various embodiments, the “max possible signal strength” is the highest scan or signal strength within the time window, which in this example is −65 dB. Accordingly, 62 is subtracted from 65 to arrive at 3. Dividing by the max may include dividing 3 by 65 to arrive at 0.046 to generate a normalized distance, which is saved into TAG_DISTANCES. This process is repeated between each antenna mapped to the storage unit where the asset tag has been predicted to be within and each reference tag of the storage unit. For example, using the illustration above, signal strength values between antennas of the antennas 832 and 834 and each of the reference tags 860 can also be normalized as described above. In this way, the precise location of the asset tag 872 is predicted within the storage unit 804 based on comparing a distance between all normalized distances, which can act as data points in an embedding.

Continuing with the second pseudocode algorithm, the Euclidian distance between the asset tag 872 and all of the reference tags 860 within the storage unit 804 is calculated using PACKAGE_DISTANCES and TAG_DISTANCES as data points in space. The space for distance calculation is defined by the mean antenna signal strengths and will have a number of dimensions equivalent to the number of antennas in ANTENNAS. Store the Euclidian distances into PACKAGE_TAG_DISTANCES. In this way each PACKAGE_DISTANCES values for each antenna represents a dimension and are averaged or otherwise aggregated to form a data point or a value in PACKAGE_TAG_DISTANCES. In an illustrative example of calculating Euclidian distance using TAG_DISTANCES, referring back to FIG. 8B, the signal strength between antenna 830 and asset tag 872 may be −72 dB (a first dimension), and the signal strength between antenna 832 and asset tag 872 may be −60 dB (a second dimension), and the signal strength between antenna 834 and asset tag 872 may b −30 dB (a third dimension) each of these values can be averaged or otherwise aggregated in vector space to represent a single data point, as illustrated for example, by the data point 880 FIG. 8C.

FIG. 8C illustrates data points in dimensional or vector space that represent the signal strength indications of FIGS. 8A and 8B, according to some embodiments. In some embodiments, “data points” thus represent a finalized value that aggregates sub-values, where the sub-values represent dimensions. In an illustrative example of calculating Euclidian distance using PACKAGE_DISTANCES, referring back to FIG. 8A, the signal strength between antenna 830 and asset tag 872 may be −72 dB (a first dimension), and the signal strength between antenna 832 and asset tag 872 may be −60 dB (a second dimension), and the signal strength between antenna 834 and asset tag 872 may be −30 dB (a third dimension) each of these values can be averaged or otherwise aggregated in vector space to represent a single data point, as illustrated for example, by the data point 880 FIG. 8C. FIG. 8C represents data points in dimensional or vector space. In some embodiments, “data points” thus represent a finalized value that aggregates sub-values, where the sub-values represent dimensions.

In some embodiments, based on a user-defined K value (e.g., 3), the reference tags with the smallest K distances from PACKAGE_TAG_DISTANCES are identified. These tag identifiers and their distances to the package may be saved as “CLOSEST_TAGS. In some embodiments, a weight for each tag is generated based at least in part on normalizing the distance in CLOSEST_TAGS into the range [0,1] (0 to 1). Then CLOSEST_TAGS can be updated with this value. Some embodiments update each tag in CLOSEST_TAGS with its X and Y value from a configuration file. As described above, in some embodiments, reference tags are placed on each storage unit in regular, fixed positions. Particular embodiments treat each storage unit as a 2-dimensional X/Y grid and record the location for each tag on this grid in the configuration file (e.g., antenna 1 is in the top left, and so is at (0, 100). Then some embodiments calculate the most likely X-coordinate of the package as the weighted average of the X-coordinates from CLOSEST_TAGS. Some embodiments, repeat this step for the Y-coordinates.

### VIII. Example System Operation

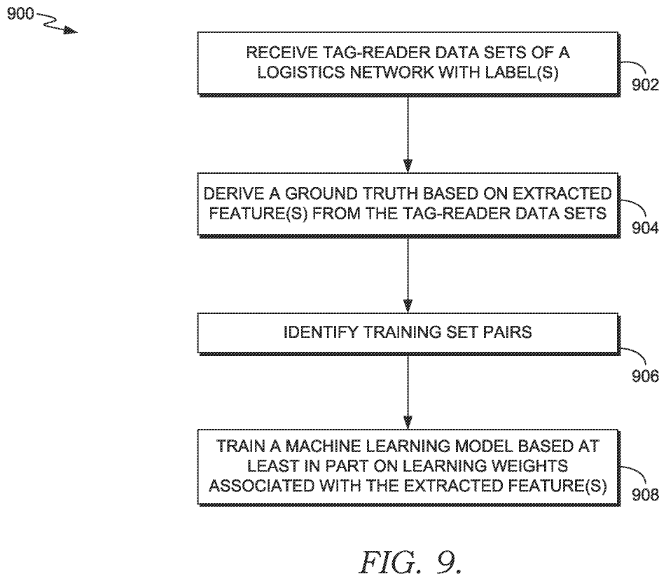

FIG. 9 is a flow diagram of an example process 900 for training a machine learning model on various historical tag-reader data sets, according to some embodiments. The process 900 (and/or any of the functionality described herein) may be performed by processing logic that comprises hardware (for example, circuitry, dedicated logic, programmable logic, microcode, and the like), software (for example, instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (for example, as described with respect to FIGS. 1-8). The computer-implemented method, the system (that includes at least one computing device having at least one processor and at least one computer readable storage medium), and/or the computer readable medium as described herein may perform or be caused to perform the process 900 or any other functionality described herein.

In some embodiments, the process 900 is performed by the neural network 705 of FIG. 7. Per block 902, particular embodiments receive tag-reader data sets of at least a portion of a logistics network (e.g., from the logistics spoke 125 of FIG. 1), each data set having a corresponding label. A “tag-reader data set” includes any historical set of information that one or more reader devices within the logistics network derives from one or more tags coupled to one or more assets and/or other enclosures (e.g., reference tags coupled to a ceiling of a shipping store). In some embodiments, a tag-reader data set includes one or more of the following: an indication that a particular reader device (e.g., an ID of the reader device) has read a particular tag (e.g., an ID of the tag), an indication that a tag has not been read, a signal strength level value associated with a tag read, a timestamp or date that a read of the particular tag occurred, and/or any other data stored to or associated with a tag—e.g., destination of the asset it is attached to, the asset size, origin of the asset, etc. In some embodiments, a tag-reader data set also includes any other suitable metadata or event data not related to tag-reader information, such as weather data (e.g., temperature or presence of a weather event, such as a hurricane), originally scheduled route, originally assigned hub destination, and the like.

In illustrative examples of labels, in use cases where predictions are asset volume or quantity of assets that will arrive at or be processed at a particular logistics facility, the label may be an asset volume (quantity) range that actually arrived or was processed at a particular facility. In use cases where predictions are sorting centers or logistics vehicles to receive re-routed assets, the label may be the particular sorting center or logistics vehicle that particular assets were actually re-routed to. In uses cases where predictions are predicted sorting center inoperability, the labels may be a binary label indicating whether the sorting facility was inoperable or not. In use cases where the predictions are predicted equipment faults, the labels can be binary labels indicating whether the piece of equipment was actually faulty (e.g., inoperable or impaired). In uses cases where the predictions are predictions are whether an asset is in distress, the labels can be binary labels indicating whether the asset was actually in distress or not in distress. In use cases where the predictions are predicted time of asset arrival, the labels can be actual time of arrival (e.g., at a sorting center, logistics vehicle, and/or final destination).

Per block 904, a ground truth is derived based on one or more extracted features from the tag-reader data sets. For example, each piece of information from a tag-reader data set is encoded (e.g., and combined via a dot product) into a feature vector and embedded in feature space to represent the ground truth of all features and the label.

Per block 906, training set pairs are identified. In some embodiments, such training set pairs are entirely different tag-reader data sets than the tag-reader data sets received at block 902, which were used to derive the ground truth. In an illustrative example of block 896, two training set pairs of the same type are paired, such as two tag-reader data sets from a same logistics facility where the label was the same (e.g., the name of a sorting facility that assets were routed to). In another example, two training set pairs of different types are paired, such two tag-reader data sets from a different logistics facility, where the labels are the same or different.

Per block 908, a machine learning model is trained based at least in part on learning weights associated with the extracted features. In other words, various embodiments learn an embedding of the training set pairs in light of the ground truth. Before a first training pass/epoch is performed, some embodiments randomly initialize the weights for all the nodes. For every training epoch, particular embodiments then perform a forward pass using the current weights, and calculate the output of each node going from left to right. The final output is the value of the last node. Some embodiments, then compare (e.g., via distance differences) the final output with the actual target (ground truth) in the training data, and measure the error using a loss function. Some embodiments, perform a backwards pass from right to left and propagate the error to every individual node using backpropagation. Some embodiments then calculate each weight's contribution to the error, and adjust the weights accordingly using, for example, gradient descent. Some embodiments then propagate the error gradients back starting from the last layer.

In an illustrative example of learning weights, some embodiments determine a distance between a ground truth feature vector representing a labeled tag-reader data set and a feature vector representing one of the training set pairs that were not labeled. Based on the loss (e.g., the difference in distance between the ground truth and a training set pair) determined by a loss function (e.g., Mean Squared Error Loss (MSEL), cross-entropy loss), the loss function learns to reduce the error in prediction over multiple epochs or training sessions. For example, some embodiments train a neural network with the mean square error loss:

$$l = \frac{1}{n} {\sum }_{i}^{n} {‖ {ù}_{i} ( t + 1 ) - {ù}_{{i}^{′}} ( t + 1 ) ‖}_{2}^{2} ,$$

where ùᵢ′(t+1) is the ground truth. Some embodiments adopt the Adam optimizer for training, with a learning rate starting from 0.0001 along with a decay factor of 0.96 at each epoch. In an illustrative example of block 908, where a prediction is asset volume, some embodiments learn for dozens of tag-reader data sets labeled asset volume 2000-3000 (representing the quantity of packages received per day at facility X) that the signal strength between readers and devices (representing a first neural network node) changed considerably (weighted lower), but a quantity of reader device reads (representing a different node) was the same across each tag-reader data set (weighted higher). For example, the actual quantity of reader device reads for a facility may have been between 2000 and 3000, which matches the label indicating the amount of actually processed/received assets. Accordingly, over many epochs, the model learns and weights higher, the tag reads and weights lower the signal strength such that the same quantity of tag reads detected across multiple tag-reader data sets (e.g., representing quantity of assets processed by facility X over multiple days) corresponds to a higher probability that asset volume for a given facility will be between 2000 and 300 and an unaffected probability of a particular asset volume even if the signal strength changes between data sets.

In another illustrative example of block 908, where a prediction is sorting center or logistics vehicle to receive re-routed assets, some embodiments learn for dozens of tag-reader data sets labeled hub X (representing a hub that multiple assets were historically routed to) that the signal strength between readers and devices (representing a first neural network node) changed considerably (weighted lower), but event data (e.g., a hurricane), quantity of reader device reads at a hub originally scheduled to receive corresponding assets, staffing personnel quantity of originally scheduled hub to receive the assets, predicted asset volume to be processed by an originally assigned hub, and/or an identity of an originally designated hub were identical across all tag-reader data sets. Accordingly, over many epochs, the model learns and weights higher, values of: the event data, the quantity of reader device reads, staffing personnel quantity, and/or identity of original hub, and weights lower the signal strength values such that the same higher weighted feature detected across multiple tag-reader data sets corresponds to a higher probability that one or more assets will get rerouted to hub X and an unaffected probability that the assets will be rerouted to hub X even if the signal strength changes between data sets.

In another illustrative example of block 908, where a prediction is sorting center or equipment fault/inoperability, some embodiments learn for dozens of tag-reader data sets labeled machine Y faulty (representing a conveyor belt that has stopped) or sorting center B inoperable, that events, such as weather (representing a first neural network node) changed considerably (weighted lower), but signal strength values between reader devices and tags, quantity of reader device reads (by the reader devices 510-1 and 520-1 of the conveyor 526), a presence or absence of a read (e.g., by the reader devices 510-1 and 520-1) were identical across all tag-reader data sets. Accordingly, over many epochs, the model learns and weights higher, values of: the signal strength, the quantity of reads, a presence or absence of a read, and weights lower the weather event such that the same higher weighted feature detected across multiple tag-reader data sets corresponds to a higher probability that one or more pieces of equipment or logistics facilities are faulty or inoperable and an unaffected probability that a piece of equipment or logistics facility is inoperable even if the weather changes between data sets.

In another illustrative example of block 908, where a prediction is whether an asset is in distress, some embodiments learn for dozens of tag-reader data sets labeled “asset in distress,” that events, such as weather (representing a first neural network node) changed considerably (weighted lower), but signal strength values between reader devices and tags, quantity of reader device reads (by the reader devices 510-1 and 520-1 of the conveyor 526), and/or a presence or absence of a read (e.g., by the reader devices 510-1 and 520-1) were identical across all tag-reader data sets with the label that the assets were in distress. Accordingly, over many epochs, the model learns and weights higher, values of: the signal strength, the quantity of reads, and/or a presence or absence of a read, and weights lower the weather event such that the same higher weighted feature detected across multiple tag-reader data sets corresponds to a higher probability that an asset is in distress and an unaffected probability that an asset is in distress even if the weather changes between data sets.

In another illustrative example of block 908, where a prediction is a time of asset arrival, some embodiments learn for dozens of tag-reader data sets labeled “2 days” (indicating that an asset took 2 days to reach its destination) that features such as location within a vehicle that an asset is in (representing a first neural network node) changed considerably (weighted lower), but events, such as weather, predicted volume, predicted sorting center/equipment inoperability, predicted asset distress, signal strength values between reader devices and tags, quantity of reader device reads (by the reader devices 510-1 and 520-1 of the conveyor 526), and/or a presence or absence of a read (e.g., by the reader devices 510-1 and 520-1) were identical across all tag-reader data sets with the label that the assets took 2 days to delivery. Some embodiments use an ensemble model to make such predictions. An ensemble model combines several model predictions to produce a single prediction. For example, predicted volume, sorting center inoperability, predicted asset distress, and the like can all be used as inputs to the ensemble model. Over many epochs, the model learns and weights higher, values of: the weather, predicted volume, predicted sorting center/equipment inoperability, predicted asset distress, signal strength, quantify of reader device reads, and/or presence/absence of reads such that the same higher weighted features detected across multiple tag-reader data sets corresponds to a higher probability that an asset will take 2 days to process and an unaffected probability that an asset will take 2 days to process even if the asset is detected at various specific locations within a hub or logistics vehicle.

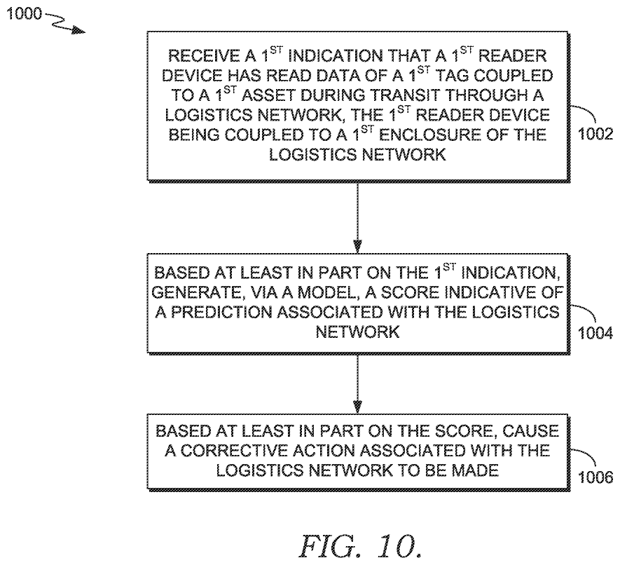

Turning now to FIG. 10, a process 1000 for causing a corrective action associated with a logistics network to be made based at least in part on a score indicative of a prediction associated with the logistics network, according to some embodiments. In some embodiments, the process 1000 occurs subsequent to the process 900 of FIG. 9, such that the model at block 1004 represents a trained model.

Per block 1002, some embodiments receive a first indication that a first reader device has read first data of a tag coupled to a first asset during transit through a logistics network. In some embodiments, the data at block 1002 is included in training data (e.g., training data input(s) 715) used to train a machine learning model on. For example, in response to the receiving of the first indication, some embodiments, store, in computer storage (e.g., RAM or non-volatile disk), second data that at least partially indicates that the first reader device has read data of the first tag coupled to the first tag during transit through the logistics network. Such data (e.g., a portion of a tag-reader data set) can then be accessed at a memory location and then based at least in part on providing the retrieved data as input into a machine learning model, the machine learning model is trained (e.g., via the process 900). In some embodiments, the second data includes the first data. Alternatively, in some embodiments, the first data at block 1002 is included in deployment data (e.g., deployment input(s) 703) used to make an inference or prediction after a model has been trained. In these embodiments, subsequent to the training, the first indication (also referred to herein as a “second” indication) is received.

In some embodiments, the first reader device is located or coupled to one of: a wearable article of clothing (e.g., the wearable reader device 116), a shipping store (e.g., the shipping store 102), a customer facility (e.g., the customer facility 118), a logistics vehicle (e.g., the logistics vehicle 414), an Unmanned Aerial Vehicle (e.g., the UAV 144), a sorting center (e.g., the logistics spoke 125 or the logistics hub 130), and a robotic machine (e.g., the delivery bot 138).

In some embodiments, the first (and/or second) data read at block 1002 includes at least one of: an ID of the first reader device, an ID of the first tag, a time that the first reader device read the first tag (i.e., a timestamp), a signal strength value associated with the read, an indicator that there was no read by the first reader device (e.g., based on the first reader device transmitting an interrogation signal but not receiving a response signal from the first tag), and/or other data described herein, such as asset origin, asset destination, asset size, and/or the like.

Per block 1004, based at least in part on the first indication, some embodiments generate, via a model, a score indicative of a prediction associated with the logistics network. In some embodiments, the “model” described herein refers to a machine learning model (e.g., a neural network), a statistical model (e.g., logistic regression models, time-series models, clustering models, decision trees), or a combination of the two. In some embodiments, a score is any suitable real number or cardinality value, such as a confidence level indicating a likelihood or hard binary classification, for example. In some embodiments, the score represents the inference prediction(s) 709 of FIG. 7.

In some embodiments, the score at block 1004 includes a first score that indicates a predicted volume of assets. A predicted volume of assets includes a predicted quantity of assets to be processed or arrive at a particular logistics enclosure, such as a sorting center. In some embodiments, the score at block 1004 indicates a predicted sorting center to receive the first asset as part of a reroute operation. For example, based on detecting an event (e.g., a hurricane) and training a model on past tag-reader data (that historically indicates that past assets were directed to a first sorting center when a second sorting center was inoperable), embodiments can predict that the first asset should be re-routed from the second sorting center to the first sorting center.

In some embodiments the score generated at block 1004 indicates a predicted logistics vehicle to receive the first asset as part of the reroute operation. For example, based on current tag-reader data indicating that an asset is located in sorting center A, a first route plan may include using a first logistics vehicle to deliver the first asset to final-mile destination B. However, the first logistics vehicle may become suddenly inoperable. In these cases, some embodiments change the route plan and predict that a second logistics vehicle, which will also arrive at sorting center A around the same time, is to now receive the first asset and deliver the first asset to final-mile destination B.

In some embodiments, the score generated at block 1004 indicates a prediction of whether a sorting facility is incapable of sorting the first asset. For example, there may be an indication received that no readers inside a sorting center are reading any tags over some time interval threshold (e.g., 5 minutes) or that the signal strength/phase angle is remaining constant (e.g., indicating that an asset has not moved). Responsively, particular embodiments predict that a sorting facility is inoperable or incapable of sorting an asset.

In some embodiments, the score generated at block 1004 that indicates a prediction of whether a piece of equipment is faulty. For example, particular reader devices within a first sorting center may read asset tags and/or reference tags coupled to a conveyor belt at the same signal strength or phase angle, which indicates that the conveyor belt assembly is not rotating or moving an of the assets. Responsively, embodiments predict that the conveyor belt apparatus is faulty. The piece of equipment can be any suitable piece of equipment, such as a forklift, a logistics vehicle, a delivery bot, a UAV, a UGV, a bulkhead door, or the like. In these embodiments, reference tags attached to these pieces of equipment that are not providing tag data to respective reader devices and/or are providing tag data at constant signal strengths or irregular intervals indicate that the equipment is faulty. For example, a tag attached to a delivery bot that is reading tags coupled to assets at a same low signal strength over a time threshold (indicating that the delivery bot is far away from the asset tag and thus not working or carrying the assets), particular embodiments generate a score that the delivery bot is inoperable.

In some embodiments, the score at block 1004 that indicates whether the first asset is in distress while traversing the logistics network. “Distress” can mean that the asset is not moving (e.g., a reader reading the tag coupled to the asset is reading the tag at the same phase angle or signal strength over a time interval threshold), or the asset is experiencing sudden spikes of movement (e.g., a reader device went from reading an asset tag at a gradually changing phase angle or signal strength to a suddenly wider phase angle and lower signal strength, indicating that the asset fell from a conveyor belt). In these embodiments, asset distress can be predicted based on readings of the asset tag that fall outside of some threshold. For example, if training data used by a machine learning model indicates that historically, a reader device reading asset tags traversing a conveyor belt read the tag data at a consistent fluctuating signal strength (indicative that the asset is coming closer at a constant speed, then moving away at a constant speed), but then the same reader device reads an asset tag outside of the consistent fluctuating signal strength, this indicates that the asset has gotten stuck on the conveyor belt, fell off the conveyor belt, got perturbed or significantly moved, which means that the asset is in distress.

In some embodiments, the score at block 1004 is indicative of a predicted time of arrival for the first asset (at any logistics enclosure). For example, referring back to FIG. 1, some embodiments store, in memory, the time of each read of the tag 104 from a respective reader device of the logistics network 100 and some embodiments also store, in the memory, the time it took to deliver the asset 106 to the destination 146. For example, the time that the first reader device in 128 of the logistics hub 130 read the tag 104 was 2 p.m. And the time that a second reader device in 128 of the same logistics hub 130 read the same tag 104 was 3 p.m. Some embodiments store, in computer memory the difference between the first read and the second read (1 hour) to indicate how fast an asset is being processed in a sorting facility. Such time or timestamp and tag data can be provided to a model, such as a machine learning model, in order to train the model to make time-based predictions. Such model can learn the tag-reader characteristics of each reader and tag throughout the entire logistics network 100. In this way, the model can be used to predict future time of arrivals. For example, using the illustration above, if a second asset traversed through the same logistics network 100, and the time that the first reader device in 128 of the logistics hub 130 read a second tag was 1 p.m. And the time that a second reader device in 128 of the same logistics hub 130 read the same second tag was 5 p.m. Some embodiments store, in computer memory the difference between the first read and the second read (4 hours) to indicate how fast an asset is being processed in a sorting facility. Accordingly, the difference between the processing of the tag 104 and the second tag at the logistics hub 130 is 3 hours (4 hours minus 1 hour). Accordingly, some embodiments would then add 3 hours to the score to indicate when the corresponding asset would arrive at the destination 146 (or the next sorting facility 136)

In some embodiments, the score generated at block 1004 is generated based at least in part on training the machine learning model, as described, for example, in FIG. 7. For example, using the example illustration above with respect to block 908 of FIG. 9, where a prediction is sorting center or logistics vehicle to receive re-routed assets, and the model learns and weights higher, values of: the event data, the quantity of reader device reads, staffing personnel quantity, and/or identity of original hub, and weights lower the signal strength values such that the same higher weighted feature detected across multiple tag-reader data sets corresponds to a higher probability that one or more assets will get rerouted to hub X. Subsequently, if the data received at block 1002 indicates the same values for the event data, the quantity of reader device reads, staffing personnel quantity, and/or identity of the original hub, then particular embodiments generate a score indicative that the first asset should be re-routed from hub Y to hub X based on the corresponding trained weight values.

In some embodiments, the receiving of the first indication that the first reader device has read first data of a first tag coupled to a first asset during transit through the logistics network (block 1002) includes receiving an indication that a first RFID antenna, of a plurality of RFID antennas, has received data from a first RFID tag coupled to the first asset. In some embodiments, the plurality of RFID antennas are included in a logistics vehicle (e.g., the logistics vehicle 414 of FIG. 4) or other logistics facility (e.g., the logistics facility 300 of FIG. 3). And based at least in part on the receiving of the first indication, particular embodiments detect a location within the logistics vehicle that the first asset is located in. In some embodiments, the score generated at block 1004 is based at least in part on the location. In some embodiments, detecting a location includes the functionality as described with respect to FIG. 3, FIG. 4, or FIG. 8A through 8C. In an illustrative example of the score, some embodiments generate a score indicative of predicted equipment fault or asset distress (e.g., based on an asset not moving but staying in the same position) or predicted time of asset arrival by triangulating, in near real-time, the location of the asset as it traverses a logistics network.

In some embodiments, in response to the receiving of the first indication (block 1002), some embodiments access a data structure (e.g., a lookup table or hash map) that indicates that the first asset is assigned to be placed in a first logistics vehicle (e.g., logistics vehicle 614), of a plurality of logistics vehicles. And based at least in part on the accessing of the data structure and the receiving of the first indication, some embodiments determine that the first asset is inside of the first logistics vehicle. In some embodiments, such functionality includes the functionality as described with respect to FIG. 6. In some embodiments, the score at block 1004 is generated based at least in part on the determining that the first asset is inside of the first logistics vehicle. For example, some embodiments generate a score indicative of time of arrival of an asset based on detecting that an asset is in a specific package car. Some embodiments also generate a score indicating that an asset is in distress (e.g., loaded into the wrong package car) based on such information. Some embodiments generate a score indicative of a hub to re-route an asset to based on a logistics vehicle that the asset is currently in.

In some embodiments, in response to the receiving of the first indication at block 1002, some embodiments access a data structure that indicates that the first reader device is located within a first logistics facility (e.g., a logistics spoke, a logistics hub, a shipping store, a customer facility). Based at least in part on the accessing of the data structure and the receiving of the first indication, some embodiments determine that the first asset is inside of the first logistics facility. In some embodiments, such functionality includes the functionality as described with respect to FIG. 1 and FIG. 3. And the score at block 1004 is based at least in part on the determining that the first asset is inside of the first logistics facility. For example, some embodiments generate a score indicative of time of arrival of an asset based on detecting that an asset is in a specific hub. Some embodiments also generate a score indicating that an asset is in distress based the asset being within a hub over a threshold period of time. Some embodiments generate a score indicative of a hub to re-route an asset to, based on a hub that the asset is currently in.

Some embodiments detect a specific location within a logistics enclosure (e.g., a logistics vehicle or logistics facility) that the first asset is at based at least in part on comparing one or more indications of signal strength values between the first reader device, and reach reference tag, of a plurality of reference tags, with one or more other indications of signal strength values between the first reader device and the first tag. In some embodiments, such functionality includes the functionality as described with respect to FIG. 3 and FIG. 8A through 8C. In these embodiments, the score at block 1004 is generated based at least in part on the detecting of the specific location. In an illustrative example of the score, some embodiments generate a score indicative of predicted equipment fault or asset distress (e.g., based on an asset not moving but staying in the same position) or predicted time of asset arrival by triangulating, in near real-time, the location of the asset as it traverses a logistics network.

Some embodiments detect an event and generate the score at block 1004 based at least on the event. An “event” is any suitable trigger, either real-world or data-based, such as some threshold being met. For example, an event can be a weather event, such as rain, snow, a hurricane, a particular temperature, etc. Some embodiments detect such weather event (or other events) based on communicatively connecting, via an application programming interface (API), with a weather service or other service to retrieve weather data and flagging the event when a threshold has been met (e.g., a hurricane detected). In another example, an event can be a traffic event, such as a car crash, traffic congestion, a sporting event, a parade, etc. In an illustrative example, some embodiments generate a score to re-route assets from a first hub to a second hub in response to the event being detected. In another example, an event can be a logistics-based event, such as a staff work shortage, a detected equipment breakage (e.g., based on RFID tag-reader data), a late-arriving logistics vehicle, or the like.

Per block 1006, some embodiments cause a corrective action associated with the logistics network to be made based at least in part on the score at block 1004. In some embodiments, block 1006 includes causing a first asset to be redirected from a first sorting facility to a second sorting facility (e.g., via a control signal to an autonomous logistics vehicle or via a notification to a user device that instructs a user to redirect (e.g., change the route of) the first asset to the second facility). In some embodiments, block 1006 includes causing the first asset to be loaded into a first logistics vehicle instead of a second logistics vehicle (e.g., via a control signal to a delivery bot that automatically loads the first asset into the first logistics vehicle instead of the originally assigned first logistics vehicle or via a notification to a user device that instructs a user to redirect the first asset to the second logistics vehicle). In some embodiments, where a prediction is that an asset will arrive at a destination at a particular time, which is late, block 1006 includes transmitting a control signal to a logistics vehicle or vessel (e.g., a delivery bot, a conveyor, or UAV) to speed up delivery/traversal of the first asset. In some embodiments, block 1006 includes transmitting a control signal to equipment (e.g., a conveyor apparatus, an autonomous forklift, etc.) to change operation of the equipment or change a route that the asset takes. For example, such control signal may speed up how fast a best of a conveyor moves. In another example, such control signal may activate a conveyor belt switch or turnout, which causes assets to switch a route it takes from a first conveyor belt apparatus to a second conveyor belt apparatus. In some embodiments, block 1006 includes transmitting a notification to a user device that indicates the prediction. For example, some embodiments transmit a notification to a user device of a relevant driver that a package that is in a vehicle she is driving should be re-routed to a particular hub. In another example, a notification can be transmitted to a user device, which indicates that more personnel should be servicing a particular sorting facility based on the prediction of asset volume being higher than normal. In another example, a control signal can be sent to a delivery bot instructing the delivery bot to retrieve a package based on a prediction that the asset is in distress. In another example, a notification can be sent to a user device, which indicates that particular equipment or a sorting facility is inoperable based on corresponding predictions.

### IX. Apparatuses, Methods, and Systems

Embodiments of the present disclosure may be implemented in various ways, including as apparatuses that comprise articles of manufacture. An apparatus or system may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### X. Example Computing Environment

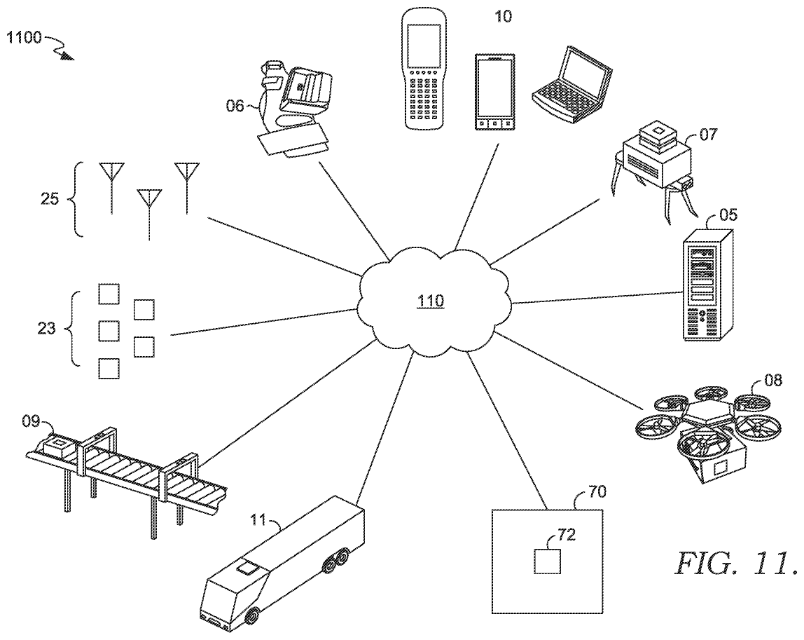

FIG. 11 is a schematic diagram of an example computing environment 1100 in which aspects of the present disclosure are employed in, according to some embodiments. As shown in FIG. 11, this particular computing environment 1100 includes one or more analysis computing entities 05 (e.g., a shipping company mainframe, cloud computing nodes, and/or logistics store desktop), a plurality of reader devices 25 (e.g., within the environment 300), a plurality of reference tags (e.g., within the environment 300), one or more target tags 72 (located on one or more assets 70), one or more source computing entities 10 (e.g., a mobile device, such as a DIAD or mobile phone), one or more logistics vehicles 11 (which include one or more additional reader devices and/or reference tags), one or more wearable reader devices 06, one or more UAVs 08 (e.g., the UAV 144 of FIG. 1), one or more delivery bots 07 (e.g., the delivery bot 138 of FIG. 1), and logistics equipment 09 (e.g., the conveyor belt assembly 525 of FIG. 5), each of which is communicatively coupled via one or more networks 510.

In some embodiments, “communicatively coupled” means that two or more components can perform data transportation between each other via a wired (e.g., Ethernet or fiber-optic medium connected in a LAN) or wireless (e.g., IEEE 802.15.4) computer protocol network. Each of these components, entities, devices, systems, and similar words used herein interchangeably may be in direct or indirect communication with one another over, for example, the same or different wired and/or wireless networks. Additionally, while FIG. 11 illustrates the various system entities as separate, standalone entities, the various embodiments are not limited to this particular architecture. In some embodiments, there are more or fewer (or combined) components than illustrated in the environment 1100.

In some embodiments, one or more components of the environment 1100 represent corresponding components as described herein. For example, in some embodiments, the source computing entity 10 represents the mobile device 103 of FIG. 1. In some embodiments, the analysis computing entity 05 represents the “server” as described herein. In some embodiments, the wearable reader device 06 represents the wearable reader device 606 of FIG. 6. In some embodiments, the logistics vehicle 11 represents any of the logistics vehicles illustrated in FIG. 1, the logistics vehicle(s) 614/616 of FIG. 6, and/or the logistics vehicle 414 of FIG. 4.

In some embodiments, each of the components of the system 200 of FIG. 2 are located within the analysis computing entity 05. In some embodiments, the components of the system 200 of FIG. 2 are distributed among the components of the environment 1100.

In various embodiments, the network(s) 110 represents or includes an IoT (internet of things) or IoE (internet of everything) network, which is a network of interconnected items (e.g., asset 70, the wearable reader device 06, the logistics vehicle 06, the environment tags 23, the delivery bot 07, the UAV 08, logistics equipment 09, and logistic server(s) 05) that are each provided with unique identifiers (e.g., UIDs) and computing logic so as to communicate or transfer data with each other or other components. Such communication can happen without requiring human-to-human or human-to-computer interaction. For example, an IoT network may include the mobile computing entity 10 that includes an application, which sends a request, via the network(s) 110, to the analysis computing entity 05 to determine or predict where the asset 70 is located. Responsively, the reader devices 25, the environment tags 23, and the asset tag(s) 72 may help generate sensor data so that the logistics server(s) 05 can analyze the data, as described herein. In the context of an IoT network, a computing device can be or include one or more local processing devices (e.g., edge nodes) that are one or more computing devices configured to store and process, over the network(s) 110, either a subset or all of the received or respective sets of data to the one or more remote computing devices (e.g., the source computing entities 10 and/or the analysis computing entity 05) for analysis. An “asset” as described herein is any tangible item that is capable of being transported from one location to another. Assets may be or include the contents that enclose a product or other items people wish to ship. For example, an asset may be or include a parcel or group of parcels, a package or group of packages, a box, a crate, a drum, a container, a box strapped to a pallet, a bag of small items, and/or the like.

In some embodiments, the local processing device(s) described above is a mesh or other network of microdata centers or edge nodes that process and store local data received from the source computing entity 10 (e.g., a user device), the analysis computing entity 05, the reader devices 25, the tag 72, the tags 23, the logistics vehicle 11, the delivery bot 07, the logistics equipment 09, and/or the wearable reader device 06 and push or transmit some or all of the data to a cloud device or a corporate data center that is or is included in the one or more analysis computing entities 05. In some embodiments, the local processing device(s) store all of the data and only transmit selected (e.g., data that meets a threshold) or important data to the one or more logistics servers 05. Accordingly, the non-important data or the data that is in a group that does not meet a threshold is not transmitted. In various embodiments where the threshold or condition is not met, daily or other time period reports are periodically generated and transmitted from the local processing device(s) to the remote device(s) indicating all the data readings gathered and processed at the local processing device(s). In some embodiments, the one or more local processing devices act as a buffer or gateway between the network(s) and a broader network, such as the one or more networks 110. Accordingly, in these embodiments, the one or more local processing devices can be associated with one or more gateway devices that translate proprietary communication protocols into other protocols, such as internet protocols.

The reader devices 25, the wearable reader device 06, and/or the reader devices within the logistics vehicle 11 (or coupled to the delivery bot 07, the UAV 08, and/or the equipment 09) are generally responsible for interrogating or reading data emitted from or located on the tags 23 and/or the tag 72. Each of the reader devices may be any suitable reader machine, manufacture, or module. For example, the reader devices 25 can be Radio Frequency Identification (RFID) readers, Near-field Communication (NFC) readers, optical scanners, optical readers, bar code scanners, magnetic ink character recognition readers, beacon readers, or the like. The reader devices can be coupled to or placed in any suitable location, such as a particular distance, orientation, and/or height from storage unit, on the ceiling of a building, on the floor of the building, one the walls of the building, and/or on any structure within a geographical area.

The tag(s) 72 are typically attached or otherwise coupled to target asset(s) 70, which need to be loaded in a particular logistics vehicle. Each of the target tag(s) 72 is generally responsible for indicating or emitting/transmitting data (e.g., to respective reader devices 25), such as an identifier that identifies the respective target tag, which can be used to predict the location of the target tag 72 (or more generally the asset 70), as described above. Each of the tags 23, and/or the target tag(s) 72 may be or include any suitable tag, machine, manufacture, module, and/or computer-readable indicia. “Computer-readable indicia” as described herein is any tag (e.g., RFID or NFC tag) information, bar code, data matrix, numbers, lines, shapes, and/or other suitable identifier that is machine-readable (and tend not to be readable by a human) because machines can process the data. For example, the target tag(s) 72 and/or the environment tags 23 can be Radio Frequency Identification (RFID) tags (active or passive), Near-field Communication (NFC) tags, optical computer-readable indicia, bar code computer-readable indicia, magnetic ink character recognition computer-readable indicia, and/or beacons or the like.

### XI. Example Analysis Computing Entity

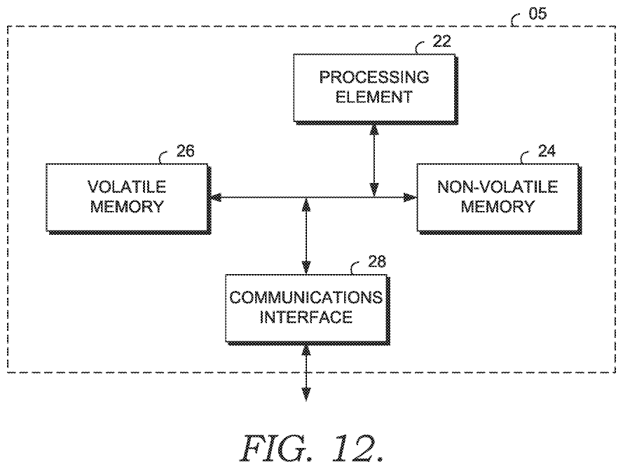

FIG. 12 is a block diagram of the analysis computing entity 05 of FIG. 11, according to particular embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, consoles input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In particular embodiments, these functions, operations, and/or processes can be performed on data, content, information/data, and/or similar terms used herein interchangeably.

As indicated, in particular embodiments, the analysis computing entity 05 may also include one or more communications interfaces 24 for communicating with various computing entities, such as by communicating data, content, information/data, and/or similar terms used herein interchangeably that can be transmitted, received, operated on, processed, displayed, stored, and/or the like.

As shown in FIG. 12, in particular embodiments, the analysis computing entity 05 may include or be in communication with one or more processing elements 20 (also referred to as processors, processing circuitry, and/or similar terms used herein interchangeably) that communicate with other elements within the analysis computing entity 05 via a bus, for example. As will be understood, the processing element 20 may be embodied in a number of different ways. For example, the processing element 20 may be embodied as one or more complex programmable logic devices (CPLDs), microprocessors, multi-core processors, coprocessing entities, application-specific instruction-set processors (ASIPs), microcontrollers, and/or controllers. Further, the processing element 20 may be embodied as one or more other processing devices or circuitry. The term circuitry may refer to an entirely hardware embodiment or a combination of hardware and computer program products. Thus, the processing element 20 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 20 may be configured for a particular use or configured to execute instructions stored in volatile or non-volatile media or otherwise accessible to the processing element 20. As such, whether configured by hardware or computer program products, or by a combination thereof, the processing element 20 may be capable of performing steps or operations according to embodiments of the present disclosure when configured accordingly.

In particular embodiments, the analysis computing entity 05 may further include or be in communication with non-volatile media (also referred to as non-volatile storage, memory, memory storage, memory circuitry and/or similar terms used herein interchangeably). In particular embodiments, the non-volatile storage or memory may include one or more non-volatile storage or memory media 22, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases (e.g., parcel/item/shipment database), database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In particular embodiments, the analysis computing entity 05 may further include or be in communication with volatile media (also referred to as volatile storage, memory, memory storage, memory circuitry and/or similar terms used herein interchangeably). In particular embodiments, the volatile storage or memory may also include one or more volatile storage or memory media 26, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 20. Thus, the databases, database instances, database management systems, data, applications, programs, program modules, scripts, source code, object code, byte code, compiled code, interpreted code, machine code, executable instructions, and/or the like may be used to control certain aspects of the operation of the analysis computing entity 105 with the assistance of the processing element 20 and operating system.

As indicated, in particular embodiments, the analysis computing entity 05 may also include one or more communications interfaces 24 for communicating with various computing entities, such as by communicating information/data, content, information/data, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the analysis computing entity 05 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, long range low power (LoRa), LTE Cat M1, NarrowBand IoT (NB IoT), and/or any other wireless protocol.

Although not shown, the analysis computing entity 05 may include or be in communication with one or more input elements, such as a keyboard input, a mouse input, a touch screen/display input, motion input, movement input, audio input, pointing device input, joystick input, keypad input, and/or the like. The analysis computing entity 05 may also include or be in communication with one or more output elements (not shown), such as audio output, video output, screen/display output, motion output, movement output, and/or the like.

As will be appreciated, one or more of the analysis computing entity's 05 components may be located remotely from other analysis computing entity 05 components, such as in a distributed system. Furthermore, one or more of the components may be combined and additional components performing functions described herein may be included in the analysis computing entity 05. Thus, the analysis computing entity 05 can be adapted to accommodate a variety of needs and circumstances. As will be recognized, these architectures and descriptions are provided for exemplary purposes only and are not limiting to the various embodiments.

### XII. Example Source Computing Entity

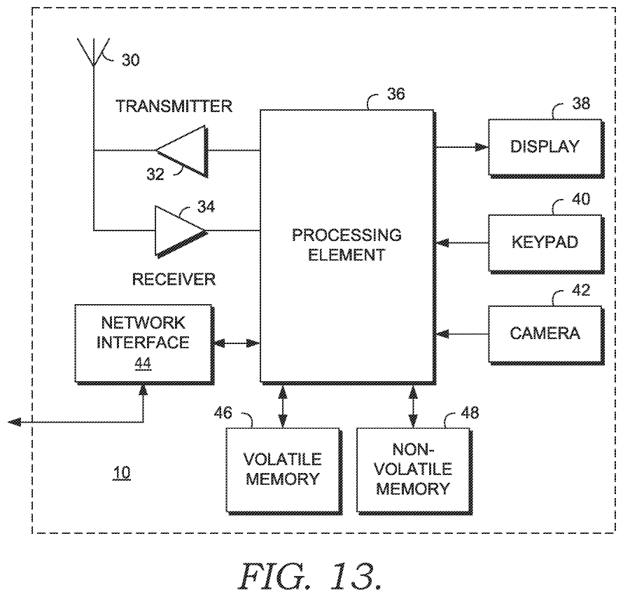

Turning now to FIG. 13, a block diagram of a source computing entity 10 (and/or the wearable reader device 06, the delivery bot 07, and/or the UAV 08) of FIG. 11, according to some embodiments. In certain embodiments, source computing entity(s) 10 may be embodied as handheld computing entities, such as mobile phones, tablets, personal digital assistants, and/or the like, that may be operated at least in part based on user input received from a user via an input mechanism. Moreover, source computing entity(s) 10 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, source computing entity(s) 10 may be utilized as onboard controllers for UAVs configured for picking-up and/or delivering packages to various locations, and accordingly such source computing entity(s) 10 may be configured to monitor various inputs (e.g., from various sensors) and generated various outputs. It should be understood that various embodiments of the present disclosure may comprise a plurality of source computing entities 10 embodied in one or more forms (e.g., kiosks, mobile devices, watches, laptops, carrier personnel devices (e.g., Delivery Information Acquisition Devices (DIAD)), etc.)

As will be recognized, a user may be an individual, a family, a company, an organization, an entity, a department within an organization, a representative of an organization and/or person, and/or the like-whether or not associated with a carrier. In particular embodiments, a user may operate a source computing entity 10 that may include one or more components that are functionally similar to those of the analysis computing entity 05. This figure provides an illustrative schematic representative of a source computing entity(s) 10 that can be used in conjunction with embodiments of the present disclosure. In general, the terms device, system, source computing entity, user device, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Source computing entity(s) 10 can be operated by various parties, including carrier personnel (sorters, loaders, delivery drivers, network administrators, and/or the like). As shown this figure, the source computing entity(s) 10 can include an antenna 30, a transmitter 32 (e.g., radio), a receiver 44 (e.g., radio), and a processing element 36 (e.g., CPLDs, microprocessors, multi-core processors, coprocessing entities, ASIPs, microcontrollers, and/or controllers) that provides signals to and receives signals from the transmitter 32 and receiver 34, respectively. In some embodiments, the source computing entity(s) 10 additionally includes other components not shown, such as a fingerprint reader, a printer, and/or the camera.

The signals provided to and received from the transmitter 32 and the receiver 34, respectively, may include signaling information in accordance with air interface standards of applicable wireless systems. In this regard, the source computing entity(s) 10 may be capable of operating with one or more air interface standards, communication protocols, modulation types, and access types. More particularly, the source computing entity(s) 10 may operate in accordance with any of a number of wireless communication standards and protocols, such as those described above with regard to the analysis computing entity(s) 05. In a particular embodiment, the source computing entity(s) 10 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the source computing entity(s) 10 may operate in accordance with multiple wired communication standards and protocols, such as those described above with regard to the analysis computing entity(s) 05 via a network interface 44.

Via these communication standards and protocols, the source computing entity(s) 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The source computing entity(s) 10 can also download changes, add-ons, and updates, for instance, to its firmware, software (e.g., including executable instructions, applications, program modules), and operating system.

According to particular embodiments, the source computing entity(s) 10 may include location determining aspects, devices, modules, functionalities, and/or similar words used herein interchangeably. For example, the source computing entity(s) 10 may include outdoor positioning aspects, such as a location module adapted to acquire, for example, latitude, longitude, altitude, geocode, course, direction, heading, speed, universal time (UTC), date, and/or various other information/data. In particular embodiments, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the computing entity's 10 position in connection with a variety of other systems, including cellular towers, Wi-Fi access points, and/or the like. Similarly, the source computing entity(s) 10 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The source computing entity(s) 10 may also comprise a user interface (that can include a display 38 coupled to a processing element 36) and/or a user input interface (coupled to a processing element 36). For example, the user interface may be a user application, browser, user interface, and/or similar words used herein interchangeably executing on and/or accessible via the source computing entity 10 to interact with and/or cause display of information from the analysis computing entity 05, as described herein. The user input interface can comprise any of a number of devices or interfaces allowing the source computing entity(s) 10 to receive information/data, such as a keypad 40 (hard or soft), a touch display, voice/speech or motion interfaces, or other input device. In embodiments including a keypad 40, the keypad 40 can include (or cause display of) the conventional numeric (0-9) and related keys (#, *), and other keys used for operating the source computing entity(s) 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in this figure, the source computing entity(s) 10 may also include an camera 42, imaging device, and/or similar words used herein interchangeably (e.g., still-image camera, video camera, IoT enabled camera, IoT module with a low resolution camera, a wireless enabled MCU, and/or the like) configured to capture images. The source computing entity(s) 10 may be configured to capture images via the onboard camera 42, and to store those imaging devices/cameras locally, such as in the volatile memory 46 and/or non-volatile memory 48. As discussed herein, the source computing entity(s) 10 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 42. The contextual data may be stored as a portion of the image (such that a visual representation of the image data includes the contextual data) and/or may be stored as metadata associated with the image data that may be accessible to various computing entity(s) 10.

The source computing entity(s) 10 may include other input mechanisms, such as scanners (e.g., barcode scanners), microphones, accelerometers, RFID readers, and/or the like configured to capture and store various information types for the source computing entity(s) 10. For example, a scanner may be used to capture parcel/item/shipment information/data from an item indicator disposed on a surface of a shipment or other item. In certain embodiments, the source computing entity(s) 10 may be configured to associate any captured input information/data, for example, via the onboard processing element 36. For example, scan data captured via a scanner may be associated with image data captured via the camera 42 such that the scan data is provided as contextual data associated with the image data.

The source computing entity(s) 10 can also include volatile storage or memory 46 and/or non-volatile storage or memory 48, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the source computing entity(s) 10. As indicated, this may include a user application that is resident on the entity or accessible through a browser or other user interface for communicating with the analysis computing entity 05 and/or various other computing entities.

In another embodiment, the source computing entity(s) 10 may include one or more components or functionality that are the same or similar to those of the analysis computing entity 05, as described in greater detail above. As will be recognized, these architectures and descriptions are provided for exemplary purposes only and are not limiting to the various embodiments.

The following embodiments represent exemplary aspects of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting:

Some embodiments are directed to a system comprising: at least one computer processor; and one or more computer storage media storing computer-useable instructions that, when used by the at least one computer processor, cause the at least one computer processor to perform operations comprising: receiving a first indication that one or more reader devices have read first data of a one or more tags coupled to one or more assets during transit through a logistics network; in response to the receiving of the first indication, storing, in computer storage, second data that at least partially indicates that the one or more reader devices have read the first data of one or more tags coupled to one or more assets during transit through the logistics network; based at least in part on providing the second data as input into a machine learning model, training the machine learning model; subsequent to the training, receiving a second indication that a first reader device has read third data of a first tag coupled to a first asset during transit through the logistics network; based at least in part on the training of the machine learning model and the second indication, generating, via the machine learning model, a score indicative of a prediction associated with the first asset; and based at least in part on the score, causing a corrective action associated with the logistics network to be made.

In any combination of the above embodiments of the system, the one or more reader devices and the first reader device are located in at least one of: a wearable article of clothing, a shipping store, a customer facility, a logistics vehicle, an Unmanned Aerial Vehicle (UAV), a sorting center, and a robotic machine.

In any combination of the above embodiments of the system, the score indicative of the prediction associated with the first asset includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.

In any combination of the above embodiments of the system, the causing the corrective action associated with the logistics network to be made includes one of: causing the first asset to be redirected from a first sorting facility to a second sorting facility as part of a reroute operation, causing the first asset to be loaded into a first logistics vehicle instead of a second logistics vehicle as part of the reroute operation, transmitting a control signal to a logistics vehicle or vessel to speed up delivery of the first asset, transmitting a control signal to equipment to change operation of the equipment or change a route that the first asset takes, and transmitting a notification to a user device that indicates the prediction.

In any combination of the above embodiments of the system, the second data includes at least one of: an ID of the one or more reader devices, an ID of the one or more tags, a timestamp that the one or more reader devices read the one or more tags, a signal strength value associated with the read, and an indicator that there was no read by the one or more reader devices of the one or more tags.

In any combination of the above embodiments of the system, the receiving of the second indication that the first reader device has read data of a first tag coupled to a first asset during transit through the logistics network includes, receiving an indication that a first RFID antenna, of a plurality of RFID antennas, has received data from a first RFID tag coupled to the first asset, the plurality of RFID antennas being included in a logistics vehicle, the operations further comprising: based at least in part on the receiving of the second indication, detecting a location within the logistics vehicle that first asset is located in, and wherein the score is based at least in part on the location.

In any combination of the above embodiments of the system, the operations further comprising: in response to the receiving of the second indication, accessing a data structure that indicates that the first asset is assigned to be placed in a first logistics vehicle, of a plurality of logistics vehicles; and based at least in part on the accessing of the data structure and the receiving of the second indication, determining that the first asset is inside of the first logistics vehicle, and wherein the score is based on the determining.

In any combination of the above embodiments of the system, the operations further comprising: in response to the receiving of the second indication, accessing a data structure that indicates that the first reader device is located in a first logistics facility; and based at least in part on the accessing of the data structure and the receiving of the second indication, determining that the first asset is inside of the first logistics facility, and wherein the score is based on the determining.

In any combination of the above embodiments of the system, the operations further comprising: detecting a specific location within a logistics enclosure that the first asset is at based at least in part on comparing one or more indications of signal strength values between the first reader device, and each reference tag, of a plurality of references tags, with one or more other indications of signal strength values between the reader device and the first tag, wherein the score is further based on the detecting of the specific location.

In any combination of the above embodiments of the system, the training of the machine learning model includes: receiving tag-reader data sets of the logistics network; deriving a ground truth based on one or more extracted features from the tag-reader data sets; identifying training set pairs; and training the machine learning model based at least in part on learning weights associated with the one or more extracted features.

In any combination of the above embodiments of the system, the operations further comprising: detecting an event, wherein the generating of the score is further based on the event.

Some embodiments are directed to a computer-implemented method comprising: receiving a first indication that a first reader device has read data of a tag coupled to a first asset during transit through a logistics network; based at least in part on the first indication, generating, via a model, a score indicative of a prediction associated with the logistics network; and based at least in part on the score, causing a corrective action associated with the logistics network to be made.

In any combination of the above embodiments of the computer-implemented method, the first reader device is located in one of: a wearable article of clothing, a shipping store, a customer facility, a logistics vehicle, an Unmanned Aerial Vehicle (UAV), a sorting center, and a robotic machine.

In any combination of the above embodiments of the computer-implemented method, the score indicative of the prediction associated with the logistics network includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.

In any combination of the above embodiments of the computer-implemented method, the causing the corrective action associated with the logistics network to be made includes one of: causing the first asset to be redirected from a first sorting facility to a second sorting facility as part of a reroute operation, causing the first asset to be loaded into a first logistics vehicle instead of a second logistics vehicle as part of the reroute operation, transmitting a control signal to a logistics vehicle or vessel to speed up delivery of the first asset, transmitting a control signal to equipment to change operation of the equipment or change a route that the first asset takes, and transmitting a notification to a user device that indicates the prediction.

In any combination of the above embodiments of the computer-implemented method, the receiving of the first indication that the first reader device has read data of a first tag coupled to a first asset during transit through the logistics network includes, receiving an indication that a first RFID antenna, of a plurality of RFID antennas, has received data from a first RFID tag coupled to the first asset, the plurality of RFID antennas being included in a logistics enclosure, the operations further comprising: based at least in part on the receiving of the first indication, detecting a location within the logistics enclosure that first asset is located in, and wherein the score is based at least in part on the location.

In any combination of the above embodiments of the computer-implemented method, the model is a machine learning model, and wherein the score is further based on training the machine learning model.

In any combination of the above embodiments of the computer-implemented method, further comprising: detecting an event, wherein the generating of the score is further based on the event.

Some embodiments are directed to one or more computer storage media having computer-executable instructions embodied thereon that, when executed, by one or more processors, cause the one or more processors to perform a method, the method comprising: receiving a first indication that a first reader device has read data of a tag coupled to a first asset during transit through a logistics network, the first reader device being coupled to a first enclosure of the logistics network; detecting an event; based at least in part on at least one of: the first indication and the event, generating a score indicative of a prediction associated with the logistics network; and based at least in part on the score, causing a corrective action associated with the logistics network to be made.

In any combination of the above embodiments of the one or more computer storage media, the score indicative of the prediction associated with the logistics network includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.

### Definitions

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

The terms first (e.g., first request), second (e.g., second request), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, the logistics server(s) 105 may “cause” a message to be displayed to a computing entity 110 (e.g., via transmitting a message to the user device) and/or the same computing entity 110 may “cause” the same message to be displayed (e.g., via a processor that executes instructions and data in a display memory of the user device). Accordingly, one or both systems may in isolation or together “cause” the effect of displaying a message.

The term “real time” includes any time frame of sufficiently short duration as to provide reasonable response time for information processing as described. Additionally, the term “real time” includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A system comprising:
at least one computer processor; and
one or more computer storage media storing computer-useable instructions that, when used by the at least one computer processor, cause the at least one computer processor to perform operations comprising:
receiving a first indication that one or more reader devices have read first data of a one or more tags coupled to one or more assets during transit through a logistics network;
in response to the receiving of the first indication, storing, in computer storage, second data that at least partially indicates that the one or more reader devices have read the first data of one or more tags coupled to one or more assets during transit through the logistics network;
based at least in part on providing the second data as input into a machine learning model, training the machine learning model;
subsequent to the training, receiving a second indication that a first reader device has read third data of a first tag coupled to a first asset during transit through the logistics network;
based at least in part on the training of the machine learning model and the second indication, generating, via the machine learning model, a score indicative of a prediction associated with the first asset; and
based at least in part on the score, causing a corrective action associated with the logistics network to be made.

2. The system of claim 1, wherein the one or more reader devices and the first reader device are located in at least one of: a wearable article of clothing, a shipping store, a customer facility, a logistics vehicle, an Unmanned Aerial Vehicle (UAV), a sorting center, and a robotic machine.

3. The system of claim 1, wherein the score indicative of the prediction associated with the first asset includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.

4. The system of claim 1, wherein the causing the corrective action associated with the logistics network to be made includes one of: causing the first asset to be redirected from a first sorting facility to a second sorting facility as part of a reroute operation, causing the first asset to be loaded into a first logistics vehicle instead of a second logistics vehicle as part of the reroute operation, transmitting a control signal to a logistics vehicle or vessel to speed up delivery of the first asset, transmitting a control signal to equipment to change operation of the equipment or change a route that the first asset takes, and transmitting a notification to a user device that indicates the prediction.

5. The system of claim 1, wherein the second data includes at least one of: an ID of the one or more reader devices, an ID of the one or more tags, a timestamp that the one or more reader devices read the one or more tags, a signal strength value associated with the read, and an indicator that there was no read by the one or more reader devices of the one or more tags.

6. The system of claim 1, wherein the receiving of the second indication that the first reader device has read data of a first tag coupled to a first asset during transit through the logistics network includes, receiving an indication that a first RFID antenna, of a plurality of RFID antennas, has received data from a first RFID tag coupled to the first asset, the plurality of RFID antennas being included in a logistics vehicle, the operations further comprising:
based at least in part on the receiving of the second indication, detecting a location within the logistics vehicle that first asset is located in, and wherein the score is based at least in part on the location.

7. The system of claim 1, wherein the operations further comprising:
in response to the receiving of the second indication, accessing a data structure that indicates that the first asset is assigned to be placed in a first logistics vehicle, of a plurality of logistics vehicles; and
based at least in part on the accessing of the data structure and the receiving of the second indication, determining that the first asset is inside of the first logistics vehicle, and wherein the score is based on the determining.

8. The system of claim 1, wherein the operations further comprising:
in response to the receiving of the second indication, accessing a data structure that indicates that the first reader device is located in a first logistics facility; and
based at least in part on the accessing of the data structure and the receiving of the second indication, determining that the first asset is inside of the first logistics facility, and wherein the score is based on the determining.

9. The system of claim 1, wherein the operations further comprising:
detecting a specific location within a logistics enclosure that the first asset is at based at least in part on comparing one or more indications of signal strength values between the first reader device, and each reference tag, of a plurality of references tags, with one or more other indications of signal strength values between the reader device and the first tag, wherein the score is further based on the detecting of the specific location.

10. The system of claim 1, wherein the training of the machine learning model includes:
receiving tag-reader data sets of the logistics network;
deriving a ground truth based on one or more extracted features from the tag-reader data sets;
identifying training set pairs; and
training the machine learning model based at least in part on learning weights associated with the one or more extracted features.

11. The system of claim 1, wherein the operations further comprising:
detecting an event, wherein the generating of the score is further based on the event.

12. A computer-implemented method comprising:
receiving a first indication that a first reader device has read data of a tag coupled to a first asset during transit through a logistics network;
based at least in part on the first indication, generating, via a model, a score indicative of a prediction associated with the logistics network; and
based at least in part on the score, causing a corrective action associated with the logistics network to be made.

13. The computer-implemented method of claim 12, wherein the first reader device is located in one of: a wearable article of clothing, a shipping store, a customer facility, a logistics vehicle, an Unmanned Aerial Vehicle (UAV), a sorting center, and a robotic machine.

14. The computer-implemented method of claim 12, wherein the score indicative of the prediction associated with the logistics network includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.

15. The computer-implemented method of claim 12, wherein the causing the corrective action associated with the logistics network to be made includes one of: causing the first asset to be redirected from a first sorting facility to a second sorting facility as part of a reroute operation, causing the first asset to be loaded into a first logistics vehicle instead of a second logistics vehicle as part of the reroute operation, transmitting a control signal to a logistics vehicle or vessel to speed up delivery of the first asset, transmitting a control signal to equipment to change operation of the equipment or change a route that the first asset takes, and transmitting a notification to a user device that indicates the prediction.

16. The computer-implemented method of claim 12, wherein the receiving of the first indication that the first reader device has read data of a first tag coupled to a first asset during transit through the logistics network includes, receiving an indication that a first RFID antenna, of a plurality of RFID antennas, has received data from a first RFID tag coupled to the first asset, the plurality of RFID antennas being included in a logistics enclosure, the operations further comprising:
based at least in part on the receiving of the first indication, detecting a location within the logistics enclosure that first asset is located in, and wherein the score is based at least in part on the location.

17. The computer-implemented method of claim 12, wherein the model is a machine learning model, and wherein the score is further based on training the machine learning model.

18. The computer-implemented method of claim 12, further comprising:
detecting an event, wherein the generating of the score is further based on the event.

19. One or more computer storage media having computer-executable instructions embodied thereon that, when executed, by one or more processors, cause the one or more processors to perform a method, the method comprising:
receiving a first indication that a first reader device has read data of a tag coupled to a first asset during transit through a logistics network, the first reader device being coupled to a first enclosure of the logistics network;
detecting an event;
based at least in part on at least one of: the first indication and the event, generating a score indicative of a prediction associated with the logistics network; and
based at least in part on the score, causing a corrective action associated with the logistics network to be made.

20. The one or more computer storage media of claim 19, wherein the score indicative of the prediction associated with the logistics network includes one or more of: a first score that indicates a predicted volume of assets, a second score that indicates a predicted sorting center to receive the first asset as part of a reroute operation, a third score that indicates a predicted logistics vehicle to receive the first asset as part of the reroute operation, a fourth score that indicates a prediction of whether a sorting facility is incapable of sorting the first asset, a fifth score that indicates a prediction of whether a piece of equipment is faulty, a sixth score that indicates whether the first asset is in distress while traversing the logistics network, and a seventh score indicative of a predicted time of arrival for the first asset.
